(19) United States
(12) Patent Application Publication
(10) Pub. No.: US 2025/0370086 A1
(43) Pub. Date: Dec. 4, 2025

(54) ANGLE-OF-ARRIVAL WITH NON-IDEAL PHASE DIFFERENCE OF ARRIVAL PATTERN

(71) Applicant: QUALCOMM Incorporated, San Diego, CA (US)

(72) Inventors: Feliciano GOMEZ MARTINEZ, Los Gatos, CA (US); Xiaoxin ZHANG, Sunnyvale, CA (US)

(21) Appl. No.: 18/676,355

(22) Filed: May 28, 2024

(51) Int. Cl. G01S 5/06; G01S 5/02

(52) U.S. Cl. CPC G01S 5/06; G01S 5/0221; G01S 5/0247; G01S 5/0264

(57) ABSTRACT

Aspects presented herein may enable a user equipment (UE) to perform angle-of-arrival (AoA) determination using non-ideal and non-directional antennas. In one aspect, a UE obtains an indication of a phase difference of arrival (PDoA) function related to the first user equipment (UE). The UE obtains a set of PDoA measurements associated with a second UE when the first UE is associated with a plurality of orientations. The UE computes, based on the PDoA function, the set of PDoA measurements, and the plurality of orientations of the first UE, a general function that is associated with a probability in which the second UE is at a set of relative directions compared to the first UE. The UE estimates, based on the computed general function, a relative direction of the second UE compared to the first UE, where the relative direction is included in the set of relative directions.

### TECHNICAL FIELD

The present disclosure relates generally to communication systems, and more particularly, to wireless communication involving tracking.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some telecommunication standards also provide positioning and tracking/ranging protocols and techniques that enable mobile network operators to provide high-accuracy location/tracking/ranging services to their subscribers. For example, 5G NR include various standards for network-based positioning that use signals and features of the 5G network to perform or improve the positioning of a device. There also exists a need for further improvements in these positioning protocols and techniques.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus obtains an indication of a phase difference of arrival (PDoA) function related to the first user equipment (UE). The apparatus obtains a set of PDoA measurements associated with a second UE when the first UE is associated with a plurality of orientations. The apparatus computes, based on the PDoA function, the set of PDoA measurements, and the plurality of orientations of the first UE, a general function that is associated with a probability in which the second UE is at a set of relative directions compared to the first UE. The apparatus estimates, based on the computed general function, a relative direction of the second UE compared to the first UE, where the relative direction is included in the set of relative directions.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of tracking in accordance with various aspects of the present disclosure.

FIG. 6 is a diagram illustrating an example user experience of a finder device locating a target device in accordance with various aspects of the present disclosure.

FIG. 7A is a diagram illustrating an example geometric configuration for angle-of-arrival (AoA) estimation using phase difference of arrival (PDoA) in accordance with various aspects of the present disclosure.

FIG. 7B is a diagram illustrating an example ideal curve for PDoA as a function of AoA in accordance with various aspects of the present disclosure.

FIG. 8A is a diagram illustrating an example of a measured plot for PDoA as a function of azimuth angle in an ultra-wideband (UWB) system using two patch antennas in accordance with various aspects of the present disclosure.

FIG. 8B is a diagram illustrating another example of a measured plot for PDoA as a function of azimuth angle in an UWB system using two patch antennas in accordance with various aspects of the present disclosure.

FIG. 9 is a diagram illustrating an example of using a camera to optically detect the position of a known object and using the detected position information to adjust the calibration of the PDoA function for a specific tracking/finder device in accordance with various aspects of the present disclosure.

FIG. 10 is a diagram illustrating an example plot of function used to compute the difference between two PDoA values in accordance with various aspects of the present disclosure.

FIG. 11 is a diagram illustrating an example of reference frames in accordance with various aspects of the present disclosure.

FIG. 12 is a diagram illustrating an example graphical description of a gradient descent with genetic algorithm (GD-GA) algorithm in accordance with various aspects of the present disclosure.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

### DETAILED DESCRIPTION

Various aspects relate generally to wireless communication and more particularly to tracking and/or ranging based on wireless communication. Some aspects more specifically relate to improving the overall performance of wireless tracking and ranging by enabling a wireless device to perform angle-of-arrival (AoA) determination using non-ideal and non-directional antennas. For example, in one aspect of the present disclosure, aspects presented herein may include first obtaining a function g(θ,ϕ) for a given wireless device (e.g., such as via a calibration process), where the function g(θ,ϕ) is capable of providing a phase difference of arrival (PDoA) value of a target device when the target device is at a direction given by angles (θ,ϕ). Then, the wireless device may use the obtained function g(θ,ϕ) when building a loss function that may be used to estimate (e.g., via minimization) the most likely position for a target. When a user of the wireless device is trying to find the direction to the target, the wireless device may be configured to instruct the user to rotate and/or move the wireless device, such that the wireless device is able to make PDoA measurements from different orientations (and/or positions). Each PDoA measurement may provide an additional equation that may constrain a set of possible values (θ,ϕ) for the function g (θ,ϕ). After sufficient measurements have been taken, there may be a single pair of (θ,ϕ) that is capable of producing a set of PDoA values consistent with the measured PDoA, which may provide the direction to the target.

Particular aspects of the subject matter described in this disclosure can be implemented to realize one or more of the following potential advantages. Aspects presented herein may improve the overall cost of wireless tracking and ranging by enabling a wireless device to perform AoA determination using non-ideal and non-directional antennas. Aspects presented herein may enable wireless devices (e.g., mobile phones) that use dedicated AoA antennas to perform AoA estimations even if the antennas have a non-ideal pattern. For example, some wireless devices may have multiple antennas, but those antennas may not be used for performing AoA measurement as they are non-ideal, or they may have the wrong position. Thus, aspects presented herein may enable those existing (non-ideal) antenna(s) to be used for measuring AoA, instead of specifying the wireless devices to include extra antennas just for measuring AoA.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

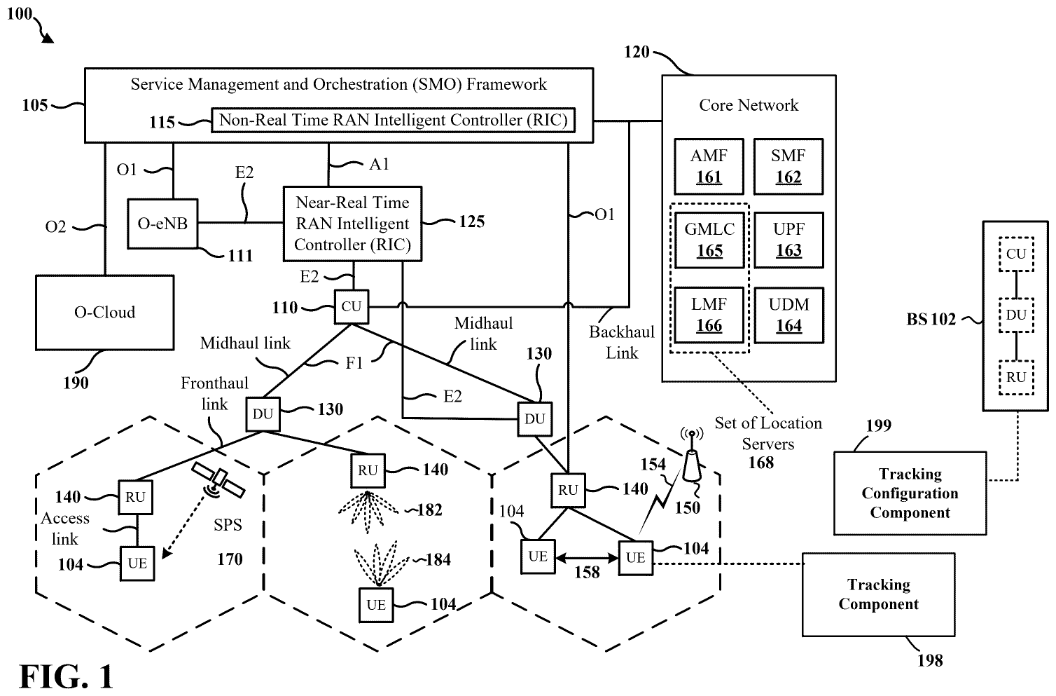

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHz-7.125 GHZ) and FR2 (24.25 GHz-52.6 GHZ). Although a portion of FR1 is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a tracking component 198 that may be configured to obtain an indication of a phase difference of arrival (PDoA) function related to the first UE; obtain a set of PDoA measurements associated with a second UE when the first UE is associated with a plurality of orientations; compute, based on the PDoA function, the set of PDoA measurements, and the plurality of orientations of the first UE, a general function that is associated with a probability in which the second UE is at a set of relative directions compared to the first UE; and estimate, based on the computed general function, a relative direction of the second UE compared to the first UE, where the relative direction is included in the set of relative directions. In certain aspects, the base station 102 may have a tracking configuration component 199 that may be configured to provide configurations and/or parameters related to tracking for the UE 104.

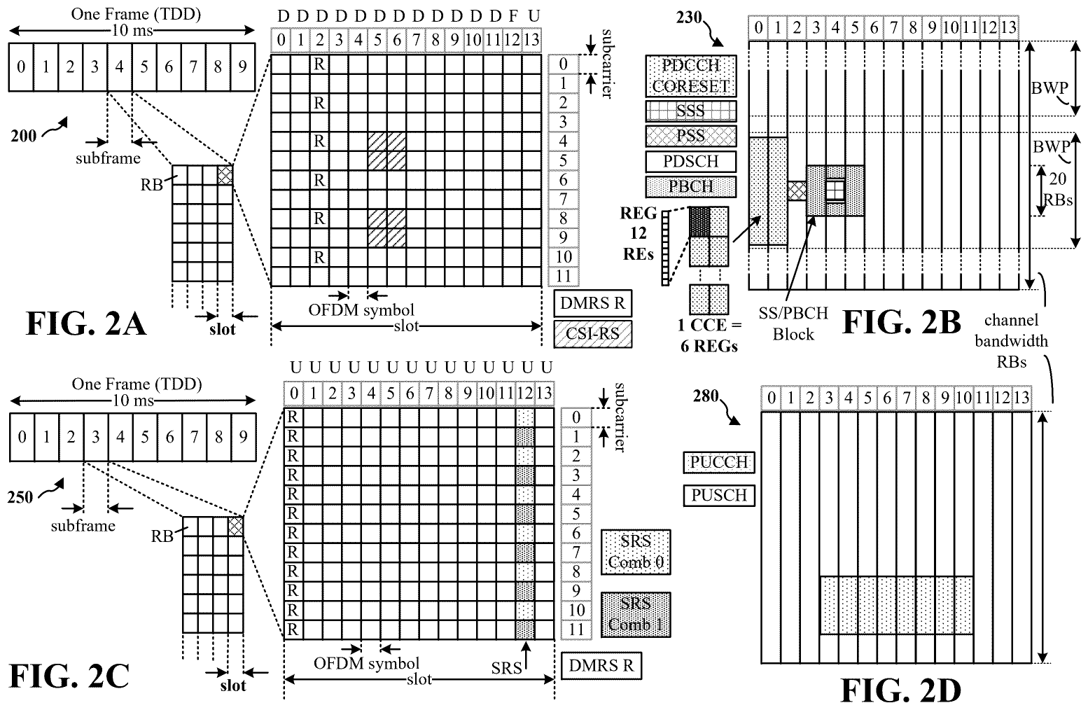

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

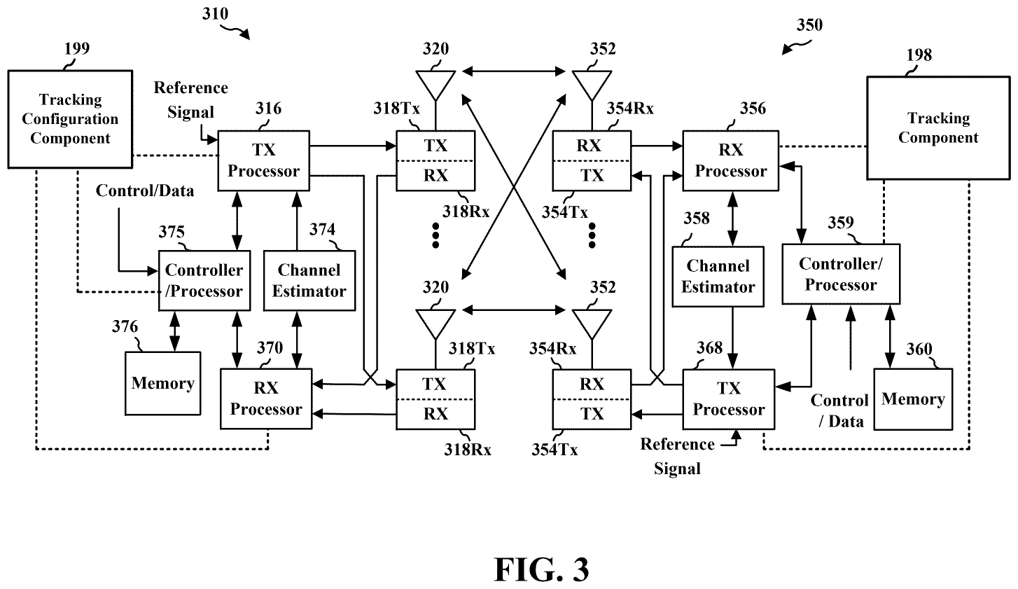

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the tracking component 198 of FIG. 1.

At least one of the TX processor 316, the RX processor 370, and the controller/processor 375 may be configured to perform aspects in connection with the tracking configuration component 199 of FIG. 1.

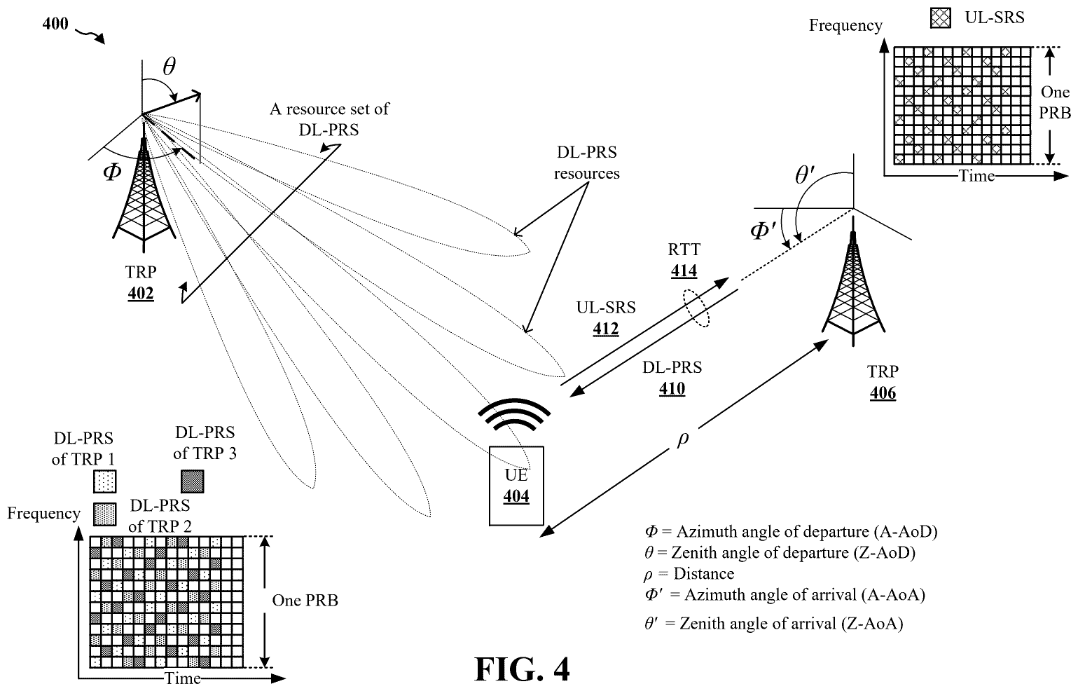

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time TsRs TX and receive DL positioning reference signals (PRS) (DL PRS) 410 at time TPRS RX. The TRP 406 may receive the UL SRS 412 at time TSRS RX and transmit the DL PRS 410 at time TPRS TX. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FRI, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

In addition to the network-based positioning described in connection with FIG. 4, various positioning methods/mechanisms have also been developed for localizing or tracking the position of a target. These positioning methods/mechanisms may be classified into active positioning (which may also be referred to and used interchangeably with “active localization”) and passive positioning (which may also be referred to and used interchangeably with “passive localization”). For active positioning, a wireless device may locate a target based on signals transmitted from the target. For example, the target may be attached or configured with a radio frequency (RF)-capable device/component, such as a tag (e.g., an RF tag), a Global Positioning System (GPS)/wireless tracker, a device/component capable of transmitting/receiving positioning reference signals, a device/component capable of performing or responding to ranging/radar operations, etc. Then, based on signals transmitted form the target (or from the RF-capable device/component attached to the target), the wireless device may calculate or estimate the location of the target. On the other hand, for passive positioning, a target may be localized and tracked without attaching an RF-capable device/component to the target. For example, RF radars, Lidars, sonars, and/or cameras are example technologies/components that may be used by a wireless device for passive positioning, where the wireless device may locate a target based on images or based on reflection of signals.

A wireless device may be able to locate and track another wireless device based on using one or more tracking technologies. For purposes of the present disclosure, tracking technologies may refer to methods and systems that are used for estimating, monitoring, and/or following the movements/locations of a target (e.g., an object, a person, an animal, a vehicle, etc.) over time. Tracking technologies may have different applications across various industries, and may use different principles and devices to achieve the tracking. Depending on implementations, some tracking technologies may be based on ranging operations, which may be referred to as ranging technologies. A ranging operation/technology may refer to a method/technique that is used to measure the distance between two points or objects. An example of ranging operation/technology may include a user locating a target device (e.g., a Bluetooth® device such as a pair of earbuds) using a mobile device (e.g., a smartphone), where the mobile device may continue to estimate the distance and/or location of the target device based on signals from the target device. Depending on the context, in some examples, the term “track/tracking” may be used interchangeably with the term “position/positioning” or “location/locationing.” For example, a wireless device may be configured to track a target based on estimating the position/location of the target using Wi-Fi technologies, which may be referred to as Wi-Fi tracking or Wi-Fi positioning/locationing. Similarly, depending on the context, in some examples, the term “tracking” may be used interchangeably with the term “ranging.” For example, a wireless device may be configured to track a target based on performing ranging against the target using UWB technologies, which may be referred to as UWB/UWB-based tracking or ranging.

The tracking technologies may be used in various fields such as surveying, navigation, robotics, telecommunications, etc. Examples of tracking technologies may include:
(1) global navigation satellite system (GNSS)/global positioning system (GPS) tracking-GNSS/GPS tracking relies on a network of satellites to provide real-time location information. GNSS/GPS receivers, often embedded in devices like smartphones, vehicles, or wearables, may determine their precise location and movement.
(2) radio-frequency identification (RFID) tracking-RFID technology uses radio waves to identify and track objects equipped with RFID tags, where these RFID tags may include electronic information that can be read by RFID readers, enabling the tracking of items in logistics, inventory management, and access control.
(3) Bluetooth® (BT) tracking-Bluetooth technology may be used for tracking by measuring the signal strength between devices. Bluetooth channel sounding (CS) (BTCS) is another technique that may also be used for tracking by measuring the round-trip-time (RTT)/the phase delay of RF signals between devices. Bluetooth beacons or tags may be attached to objects or carried by individuals, and their proximity to Bluetooth receivers may be used to estimate their location.
(4) Wi-Fi® tracking-Wi-Fi tracking may involve using signals from Wi-Fi access points (APs) to estimate the location of target devices. This tracking method is often suitable for indoor environments, such as malls and airports, for tracking people or assets.
(5) cellular tracking—mobile network infrastructure may be able to track devices through the triangulation of cell tower signals. The approximate location of a mobile device can be determined by analyzing the signals it receives from nearby cell towers.
(6) inertial navigation systems—these systems may use accelerometers and gyroscopes to track changes in velocity and orientation.
(7) computer vision tracking—advanced computer vision technologies, including object recognition and tracking algorithms, may enable cameras and sensors to track the movement of objects or people based on visual data.
(8) ultra-wideband (UWB) tracking—UWB tracking may utilize signals with very high frequency ranges or bandwidths. UWB technology transmits data using a broad spectrum of frequencies, enabling precise and accurate tracking of objects or individuals in both indoor and outdoor environments. UWB tracking systems typically operate in the frequency range of 3.1 to 10.6 gigahertz.

As discussed above, ranging operations/technologies may refer to methods/techniques that is used to measure the distance between two points or objects. Examples of ranging operations/technologies may include:
(1) triangulation—triangulation involves measuring the angles between an observer and two known points or landmarks. By using trigonometry, the distance to the object may be calculated or estimated.
(2) time of flight (ToF)—ToF technology measures the time taken for a signal (such as light or sound) to travel from a transmitter to a target and back to a receiver. By knowing the speed of the signal, usually the speed of light or sound, the distance may be calculated or estimated.
(3) GNSS—GNSS systems, such as GPS, global navigation satellite system (GLONASS), Galileo, and BeiDou, use signals from satellites to determine the position of a receiver on Earth. By analyzing the time it takes for signals from multiple satellites to reach the receiver, its position (including distance) may be calculated or estimated.
(4) RFID—RFID technology uses electromagnetic fields to automatically identify and track tags attached to objects. The distance between the reader and the RFID tag may be estimated based on the strength of the received signal.
(5) ultrasonic ranging—ultrasonic ranging involves emitting ultrasonic pulses and measuring the time it takes for the pulses to bounce back from the object. The speed of sound in the medium determines the distance.
(6) laser ranging (e.g., light detection and ranging (Lidar))—laser ranging uses lasers to measure the distance to a target by calculating the time it takes for laser pulses to travel to the target and back.

Among the aforementioned tracking/ranging technologies, UWB, Bluetooth, and/or Wi-Fi based tracking/ranging have continued to be widely used and developed for most wireless devices (e.g., consumer devices such as mobile phones, smart watches, etc.) due to their accessibility and tracking/ranging precisions.

UWB tracking/ranging may refer to using a UWB device/technology to locate and track objects, people, or assets within a certain range. A UWB device (e.g., a device that is capable of performing UWB tracking/ranging) may use pulse-based radio signaling (e.g., Short-pulse-UWB) instead of orthogonal frequency division multiplexing (OFDM)-based signaling (e.g., Multi-Band (MB)-OFDM-UWB (MB-OFDM-UWB)). Short-pulse-UWB signaling may transmit with the energy for each bit spread over the entire UWB channel bandwidth (e.g., 1.37 GHz, 4 GHZ, etc.) with varying pulse amplitude and/or pulse polarity without using a RF carrier while MB-OFDM-UWB may transmit each bit using a 4 MHz bandwidth channel.

Using short-pulse-UWB signaling systems may provide several advantages over MB-OFDM-UWB signaling systems and other OFDM-based systems. For example, a short-pulse-UWB signaling system may provide better fading characteristics (e.g., Gaussian-modeled fading versus Rayleigh-modeled fading, and/or less than 1% of channels experiencing 2 dB or more fading) than an MB-OFDM-UWB signaling system. As other examples, a short-pulse-UWB signaling system may operate accurately without employing FEC (Forward Error Correction), using no-rake processing, with lower peak-to-average RF, and/or with longer battery life than an MB-OFDM-UWB signaling system. Short-pulse-UWB also does not use traditional modulation and demodulation techniques such as Fast Fourier Transforms (FFT), but may use time-domain or space-time processing techniques. Short-pulse-UWB may utilize various shapes (e.g., Gaussian pulses, Monocycle pulses, Hermite pulses, etc.) and the shape used may be chosen based on their properties in time and frequency domains among other factors, such as Bandwidth utilization, Interference Mitigation, Power Spectral Density, Multipath fading and inter-symbol interference, design complexity, power consumption, range, tradeoffs for ultra-fast sampling, etc. Short-pulse-UWB, in some cases, may benefit from a high speed Analog-to-Digital converter (ADC) and a high speed Digital-to-Analog Converter (DAC) to be able to handle the very wide frequency band used; however, there may be other ways to handle the need for ultra-fast sampling such as using Time Hopping techniques, Direct Sequence coding techniques, etc.

MB-OFDM-UWB may divide up spectrum into several frequency sub-bands and OFDM is applied within each band; whereas, other OFDM systems may typically operate within a fixed frequency band. The complex waveform created by combining the multiple-sub-bands results in a final waveform that used for transmission for MB-OFDM-UWB. MB-OFDM-UWB also varies from other OFDM systems by not using a guard interval, using simpler modulation schemes like Binary Phase Shift keying (BPSK) or Quadrature phase-shift keying (QPSK) vs. 64 or 256 Quadrature Modulation (QAM), utilizes a constant power level whereas other OFDM systems may utilize power control for varying channel conditions, etc.

Bluetooth tracking/ranging may refer to using Bluetooth device/technology to locate and track objects, people, or assets within a certain range. This technology may rely on Bluetooth-enabled devices, such as smartphones, tablets, or specialized Bluetooth tags, to communicate with each other and determine their relative positions.

Bluetooth tracking may include beacon-based tracking and Bluetooth low energy (LE) tracking. Beacon-based tracking may involve deploying Bluetooth beacons that emit Bluetooth signals at regular intervals. These signals are picked up by Bluetooth-enabled devices in the vicinity, such as smartphones or tablets. By measuring the signal strength and timing of these beacon signals, the receiving devices can estimate their proximity to the beacon. This information may then be used to determine the location of the Bluetooth-enabled device within the range of the beacon. Bluetooth LE tracking may enable devices to communicate over short distances while consuming minimal power. Bluetooth LE tracking systems may include attaching tags to objects or carried by individuals, and Bluetooth LE receivers (such as smartphones or dedicated receivers) that scan for these tags. The receivers detect the signals transmitted by the tags and use signal strength and other parameters to estimate the distance between the tag and the receiver. By triangulating signals from multiple receivers, the system can determine the location of the tagged object or person. Bluetooth channel sounding (CS) is a technique used in Bluetooth communication to measure time/phase delay of BT signals, such that distance between wireless devices may be estimated/measured more accurately.

Wi-Fi tracking/ranging may refer to using a Wi-Fi capable device/technology for monitoring and tracking the movement of devices within a Wi-Fi network's coverage area. Wi-Fi tracking may rely on the unique media access control (MAC) addresses of Wi-Fi-enabled devices, such as smartphones, tablets, and laptops, to identify and track them as they move within the network's range. For example, Wi-Fi tracking utilizes Wi-Fi access points (APs), which are devices that provide wireless network connectivity to devices within their range. These access points continuously broadcast Wi-Fi signals, allowing Wi-Fi-enabled devices to connect to the network. When Wi-Fi-enabled devices come within range of Wi-Fi access points, they may be configured to automatically send out probe requests, seeking available networks to connect to. Wi-Fi access points receive these probe requests and respond with probe responses containing information about the network, such as the service set identifier (SSID) and signal strength. Each Wi-Fi-enabled device may have a unique MAC address associated with its network interface. Wi-Fi tracking systems capture these MAC addresses from the probe requests and responses exchanged between devices and access points. By monitoring the signal strength and timestamps of probe requests and responses from multiple access points, Wi-Fi tracking systems may triangulate the position of Wi-Fi-enabled devices within the network's coverage area.

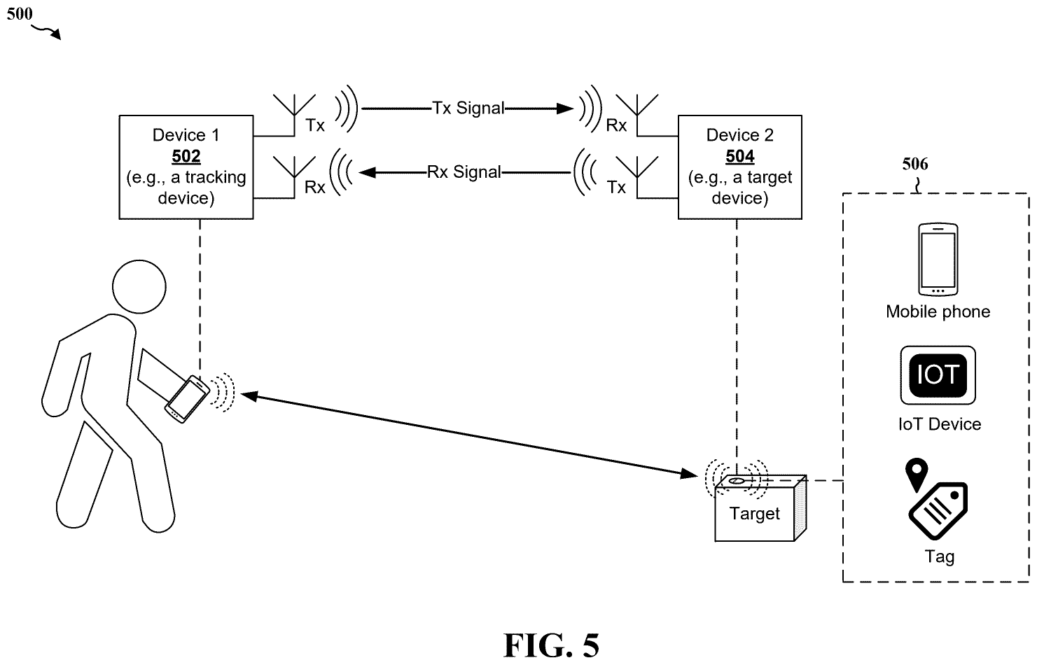

FIG. 5 is a diagram 500 illustrating an example of tracking (e.g., active positioning) in accordance with various aspects of the present disclosure. A first device 502 (which may also be referred to as a “tracking device” or a “finder device” for purposes of the present disclosure) may be able to locate a second device 504 (which may also be referred to as a “target” or a “target device” for purposes of the present disclosure) based on transmitting signals (which may be referred to as “transmission (Tx) signals”) to the second device 504, and receive signals (which may be referred to as “reception (Rx) signals”) from the second device 504. Depending on implementations, the Rx signals may be signals reflected from the second device 504 (e.g., based on the Tx signals) or signals generated by the second device 504. Then, based on the time-of-flight (ToF) of the Tx signals and the Rx signals, the first device 502 may estimate the distance of the second device 504 from the first device 502. In some configurations, if the first device is also capable of measuring the angle-of-arrival (AoA) of the Rx signals, the first device 502 may also be able to estimate the direction of the second device 504 from the first device 502 (which may be referred to as the relative direction from the first device 502). As shown at 506, the second device 504 may be a mobile phone, an Internet of Things (IoT) device, or a tag (e.g., an RFID tag), and the localizing and/or tracking of the second device 504 may be based on using Bluetooth® tracking, Wi-Fi tracking, or UWB tracking, etc.

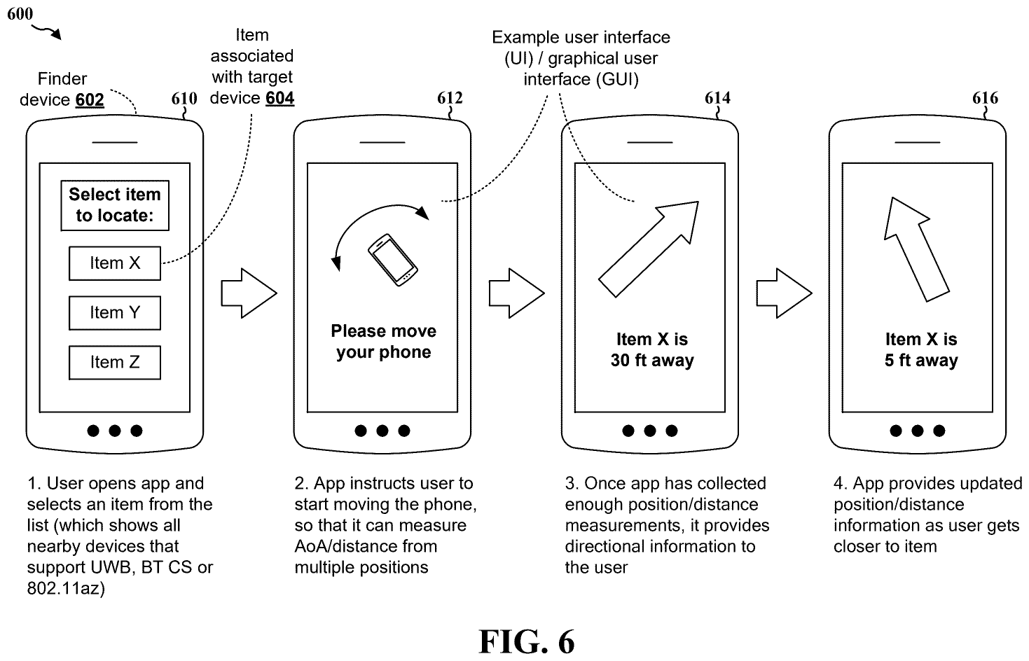

FIG. 6 is a diagram 600 illustrating an example user experience of a finder device locating a target device in accordance with various aspects of the present disclosure. As shown at 610, a finder device 602 (e.g., a mobile phone) or an application running on the finder device 602 may instruct the user (e.g., via a user interface (UI), where the UI may be a graphical user interface (GUI)) to select an item (e.g., from a list of detected items) for tracking/locating. As shown at 612, after the user selects an item (e.g., item X) that is associated with a target device 604 (e.g., an RFID tag, a pair of Bluetooth earbuds, etc.), the finder device 602 may instruct the user to move the finder device 602, such that the finder device 602 may be able to measure the distance and/or AoA between the finder device 602 and the target device 604 from multiple positions. As shown at 614, after the finder device 602 has collected sufficient AoA/distance measurements, the finder device 602 may start providing directional information of the target device 604 to the user, such as by showing the direction and the distance of the target device 604 with respect to the finder device 602. Then, as shown at 616, the finder device 602 may continue to update the directional information of the target device 604 as the user moves, and may stop the update after the user locates the target device 604 (e.g., after the finder device 602 is within a threshold distance of the target device 604).

While most finder/tracking devices may be able to wirelessly determine the relative direction/position of a target device based on estimating the AoA of a wireless signal transmitted by the target device, those finder/tracking devices may specify using at least a pair of antennas (e.g., using a minimum of two antennas) to measure the phase difference of arrival (PDoA) of the wireless signal. As there may be a defined/known mathematical relationship between the AoA (e.g., variable θ) and the PDoA (e.g., variable ψ), the finder/tracking devices may measure the PDoA (ψ) and then invert the relationship to obtain θ. In other words, the AoA may be a variable of the PDoA function.

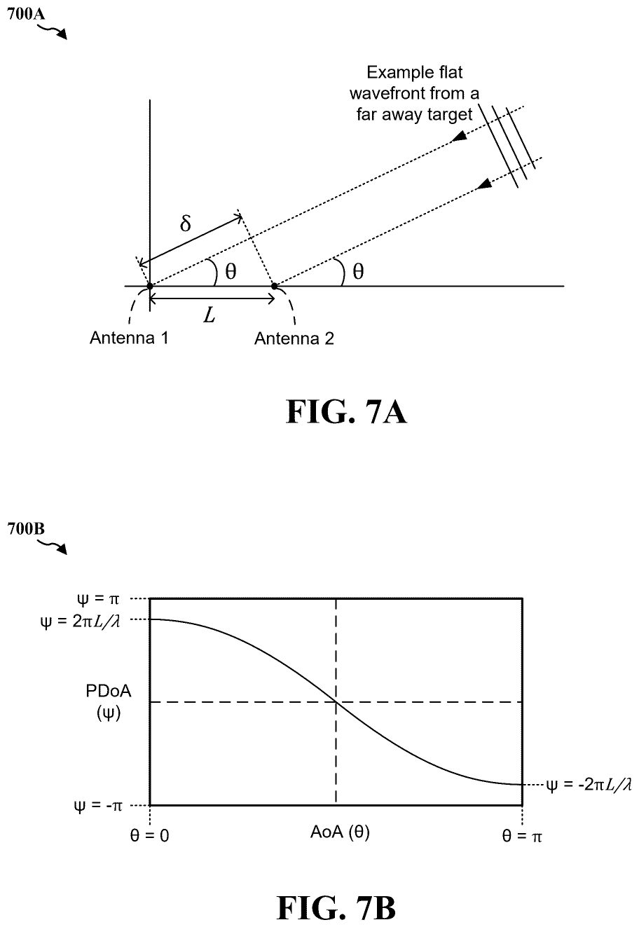

FIG. 7A is a diagram 700A illustrating an example geometric configuration for AoA estimation using PDoA in accordance with various aspects of the present disclosure. Two antennas (e.g., antenna 1 and antenna 2) of a tracking/finder device (e.g., a smartphone, the first device 502, the finder device 602, etc.) may be separated by a distance L and the AoA from a target is θ. Then, the radio signal may head to travel an extra distance δ to one of the antennas (e.g., antenna 1), with δ=L·cos θ.

Consider an ideal tracking/finder device (e.g., a smartphone, the first device 502, the finder device 602, etc.) with a pair of ideal isotropic antennas forming a vector \vec{a} with length L=∥\vec{a}∥, where the tracking/finder device is at the origin of a coordinate system. Assume the target is in a position given by vector \vec{x}_{T}. Vector \vec{x}_{T} forms an angle θ (e.g., the AoA) with the direction of antenna vector \vec{a}.

FIG. 7B is a diagram 700B illustrating an example ideal curve for PDoA (ψ) as a function of AoA (θ) in accordance with various aspects of the present disclosure. Under ideal conditions, the PDoA (ψ) measured by the system may be given by the equation:

$$ψ = g ( θ ) = \frac{2 π L}{λ} cos θ \qquad ( 1 )$$

where function g(·) may be referred to as the PDoA function. In this ideal example, function g(·) may be dependent just on the angle θ. This may assume that the tracking/finder device has a rotational symmetry around the antenna vector \vec{a}. Assuming that

$$L < \frac{λ}{2} ,$$

there may be a one-to-one mapping between θ and ψ, so the function may be inverted to obtain θ:

$$θ = arc cos ( ψ \cdot \frac{λ}{2 π L} ) \qquad ( 2 )$$

However, most tracking/finder devices may have antenna configurations that produce a non-ideal PDoA function g(θ). For example, antennas may be embedded in a wireless device (e.g., a smartphone) with other nearby components (e.g., battery, display, other antennas, etc.) that may cause signal reflections. Thus, an incoming wireless signal may be affected by the reflection before it reaches at least one of the antennas. One effect of the reflection is that the PDoA measured by the antenna pair may not follow the formula described in connection with Equation (1), which then has the side effect that Equation (2) may not be used to recover the spatial angle θ.

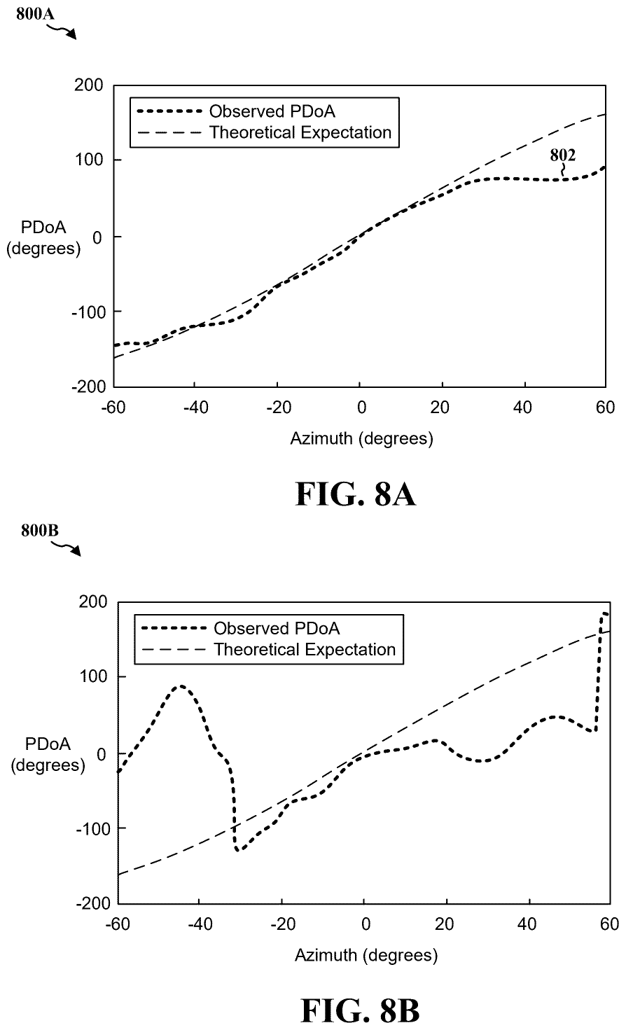

In addition to the effect of nearby components, it is also possible for the antennas themselves to have a PDoA-vs-AoA response that deviates from the theoretical equation given in Equation 1. For example, FIG. 8A is a diagram 800A illustrating an example of a measured plot for PDoA as a function of azimuth angle in an UWB system using two patch antennas in accordance with various aspects of the present disclosure. As shown at 802, the PDoA curve appears not to be invertible between 30 degrees and 40 degrees Azimuth, where the PDoA curve departs from the theoretical prediction, and all AoA angles between 30 to 40 degrees are mapped to the same PDoA (ψ)=70°, making the function g(θ) non-invertible in that region.

FIG. 8B is a diagram 800B illustrating another example of a measured plot for PDoA as a function of azimuth angle in an UWB system using two patch antennas in accordance with various aspects of the present disclosure. This example shows a more extreme case in which multiple different AoA angles may be mapped to the same PDoA angle. For example, five different AoA angles may be mapped to the same PDoA (ψ)=0°.

The example illustration of PDoA function g(·) assumed that there is a rotational symmetry around the antenna vector \vec{a}, so its value may be dependent just on the angle θ. However, in a real system with nearby reflectors (e.g., a mobile device with multiple components surrounding its antennas), this rotational symmetry may be lost, and the PDoA function g(·) may depend on two angles:

$$ψ = g ( θ , ϕ ) \qquad ( 3 )$$

where θ∈[0, π] is the angle subtended by the target position vector \vec{x}_{T} and \vec{a}, while ϕ∈[0, 2π] indicates an angle of rotation around d. In an ideal system the PDoA function g(·) may not depend at all on angle ϕ, but in the non-ideal system the PDoA function g(·) may depend on both θ and ϕ. In some examples, the PDoA function may be used for calculating an ideal or hypothetical PDoA value for a signal from a given set of points (θ,ϕ), where θ may be azimuth and ϕ may be elevation.

One main problem in a non-ideal system is that the function g(·) may become non-invertible, which may happen when two different pairs of angles (θ₁, ϕ₁) and (θ₂, ϕ₂) are able to produce the same PDoA angle ψ:

$$ψ = g ( {θ}_{1} , {ϕ}_{1} ) = g ( {θ}_{2} , {ϕ}_{2} ) but ( {θ}_{1} , {ϕ}_{1} ) \neq ( {θ}_{2} , {ϕ}_{2} ) \qquad ( 4 )$$

This may indicate that given a measured PDoA angle ψ, the function g(·) may not be inverted easily to obtain the real θ and ϕ that produce it. While some systems may have attempted to address this problem by using carefully designed antennas with directional patterns that prevent reflections from nearby components from reaching the antennas, they may have the following negative side effects. First, antennas are directional, so they may not be able to receive signals from certain directions (e.g., they may be blind when the user is holding the phone in certain orientations relative to the target). Second, because the antennas are directional, they may not be used for applications (such as Wi-Fi) that specify good performance in all orientations. This means that the antennas used for measuring AoA may not be shared, and additional antennas may be specified to be added to the device. Third, because dedicated directional antennas are specified to be added, the cost of the phone increases, and the printed circuit board (PCB) area for antenna location grows.

Aspects presented herein may improve the overall cost of wireless tracking and ranging by enabling a wireless device to perform AoA determination using non-ideal and non-directional antennas. Aspects presented herein may enable wireless devices (e.g., mobile phones) that use antennas not originally designed for measuring AoA to perform AoA estimations even if the antennas have a non-ideal pattern, such as described in connection with FIGS. 8A and 8B. For example, in one aspect of the present disclosure, aspects presented herein may include first obtaining the function g(θ,ϕ) for a given wireless device (e.g., such as via a calibration process), where the function g(θ,ϕ) is capable of providing a phase difference of arrival (PDoA) value of a target device when the target device is at a direction given by angles (θ,ϕ). Then, the wireless device may use the obtained function g(θ,ϕ) (instead of the ideal g(·) from Equation (1)) when building a loss function that may be used to estimate (e.g., via minimization) the most likely position for a target. When a user of the wireless device is trying to find the direction to the target, the wireless device (or an application/software running on the wireless device) may be configured to instruct the user to rotate and/or move the wireless device (while the wireless device tracks its own movements such as using a camera, an accelerometer, a gyroscope, a magnetometer, an inertial measurement unit (IMU), etc.), such that the wireless device is able to make PDoA measurements from different orientations (and/or positions). Each PDoA measurement (e.g., from a different orientation/position) may provide an additional equation that may constrain a set of possible values of the pair of angles (θ,ϕ). After sufficient measurements have been taken, there may be a single pair of (θ,ϕ) that is capable of producing a set of PDoA values consistent with the measured PDoA, which may provide the direction to the target. In one example, aspects presented herein took a mathematical approach of building a loss function μ(θ,ϕ) that represents the mismatch between the measured PDoA and the hypothetical PDoA for a given candidate pair (θ,ϕ), and then find the (θ,ϕ) that minimizes the loss function.

In one aspect of the present disclosure, a tracking/finder device (e.g., the first device 502, the finder device 602, a mobile phone, a UE, etc.) may be configured to obtain a PDoA function (e.g., g(θ,ϕ)) related to the tracking/finder device. For example, the tracking/finder device may obtain the PDoA function via a calibration process, based on a lookup table (LUT) or a pre-configuration, and/or receive the PDoA function from another device (e.g., from a similar model device) or a network entity, etc.

In one example, to obtain the PDoA function via a calibration process, the tracking/finder device may be configured to be installed inside a controlled environment (e.g., such as in an anechoic chamber) where a target device may be positioned at various positions (r,θ,ϕ) relative to the tracking/finder device's frame of reference (which may also be referred to as a “reference frame”). For example, this may be achieved by either keeping the tracking/finder device fixed and moving the target device, or by keeping the target device fixed and rotating the tracking/finder device, or a combination of both methods. For purposes of the present disclosure, a frame of reference may refer to a set of coordinates that may be used to determine positions (and velocities) of objects in that frame, and different frames of reference may move relative to one another.

For each position of the target device and/or the tracking/finder device, the target device may be configured to send a wireless signal, and the tracking/finder device may measure and obtain the PDoA (ψ) of the wireless signal at each position using at least a pair of antennas (which may also be referred to as an “antenna pair”).

In principle, the PDoA (ψ) may depend on the three-dimensional (3D) coordinates (r,θ,ϕ) of the target device relative to the tracking/finder device. However, if r (e.g., the distance between the tracking/finder device and the target device) is much larger than the distance between the antennas and their nearby reflectors (e.g., other hardware components surrounding the antennas), then the function g(r,θ,ϕ)=g(θ,ϕ), that is, g(·) may not depend on the distance r, and may just depend on angles θ and ϕ.

The calibration process may then measure g(·) for a sufficient number of values of (θ,ϕ)∈{[0,2π]×[0,π]}. The resolution chosen may depend on the amount of time available for this process and/or the specified AoA accuracy for a specific product. The calibration process may be performed for various RF frequencies in order to have a representative sample of all the frequencies to be used when the tracking/finder device is in production. For example, if the tracking/finder device uses UWB radios, then the tracking/finder device may be specified to be calibrated at UWB channels 5 to 12. On the other hand, if the tracking/finder device uses Wi-Fi, the tracking/finder device may be specified to be calibrated in the 2.4 GHZ, 5 GHZ, and 6 GHz bands (and potentially at different channels inside each band). Finally, the calibration process may be repeated with several different units of each tracking/finder device model, in order to take into account potential variability in g(·) due to component tolerances.

After the calibration process has been completed, the results may be represented in different ways, depending on system-specific constraints on memory or computing resources. For example, in some implementations, the results may be stored/represented as a lookup table, with some interpolation methods for values not found in the lookup table. In some implementations, the results may be stored/represented as a smooth mathematical function (e.g., a polynomial or a sum of trigonometric functions of (θ,ϕ)).

Regardless of the method used for storing or computing it, at this point it may be assumed that there is a function g(θ,ϕ) that is capable of approximating the actual PDoA (ψ) measured by the pair of antennas in the tracking/finder device, when the target device is at (θ,ϕ).

It may be noted that the angles (θ,ϕ) mentioned above are the spherical coordinates relative to the tracking/finder device's reference frame. They may not be angles relative to the antenna vector à, because it is possible that the antenna vector \vec{a} is not aligned with the any of the (x, y, z) axes of the tracking/finder device's reference frame.

There may be other considerations that deal with potential device-to-device variation. When manufacturing high-volume consumer products, it may be typical to select a representative sample of the products and to use those samples to obtain a representative PDoA function g(θ,ϕ) for all the devices of the same model. If there is a large device-to-device variation, it is possible that a single PDoA function g(θ,ϕ) may not correctly capture the behavior of every device. In that case, a manufacturer may perform some additional per-device calibration to capture a few data points for each device that provides enough information to modify the PDoA function g(θ,ϕ) so that it correctly describes the behavior of that specific device.

An additional consideration is potentially modeling the impact of the user hand holding the tracking/finder device on the PDoA function (e.g., due to the effect of RF signal absorption by human body potentially affecting each antenna differently). A manufacturer may decide to estimate the PDoA function g(θ,ϕ) for different hand/device positions (e.g., right hand versus (vs) left hand, portrait mode vs landscape mode, with a device case vs without a device case, etc.) and then store different variants of g(θ,ϕ) on the tracking/finder device for later use. The tracking/finder device may use information from its sensors (e.g., IMU sensors, camera, touch screen pattern, etc.) to determine how the user is holding the tracking/finder device at any given time, and then use that information to use the correct version of g(θ,ϕ).

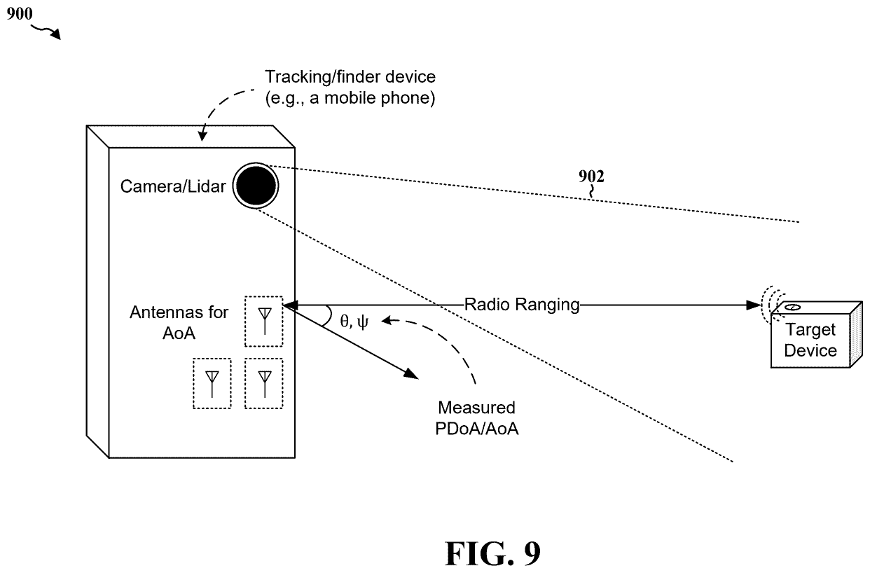

FIG. 9 is a diagram 900 illustrating an example of using a camera to optically detect the position of a known object and using the detected position information to adjust the calibration of the PDoA function for a specific tracking/finder device in accordance with various aspects of the present disclosure. In some implementation, other mechanisms for obtaining the device-specific PDoA function g(θ,ϕ) may be available, such as using optical devices (e.g., camera(s), lidar(s), etc.).

For example, as shown at 902, a user may be instructed to put a target device (such as an earbud, or an earbuds case, or another tracking/finder device, etc.) in front of the tracking/finder device (e.g., a mobile phone), in such a way that the camera/lidar of the tracking/finder device is able to detect it. The tracking/finder device may then use the camera (and/or other sensors such as time-of-flight (ToF) sensors) to optically measure the distance from the tracking/finder device to the target device, and also the azimuth/elevation relative to the tracking/finder device's reference frame. While this is happening, the tracking/finder device and the target device may be configured to perform radio-based ranging and PDoA/AoA measurements, and then the tracking/finder device may use the information obtained from the camera/lidar to adjust the calibration for the PDoA function g(θ,ϕ). This adjusted PDoA function g(θ,ϕ) may later be used when performing PDoA/AoA measurements again other devices.

For purposes of the illustration, it may be assumed that a tracking/finder device has: (1) support for one or more wireless tracking/ranging technologies such as described in connection with FIG. 5, (2) two or more antennas (e.g., at known locations relative to the body of the tracking/finder device), and (3) an approximation of the PDoA function g(θ,ϕ) for the tracking/finder device, which may be obtained via a calibration process as described above, and (4) a system that is capable of tracking the position and orientation of the tracking/finder device (e.g., relative to an arbitrary frame of reference), such as using information coming from a camera and/or an IMU, etc. It may also be assumed that the target device supports a wireless ranging technology compatible with the ones supported by the end-user device.

While most examples described herein may be related to a user carrying a mobile phone moving around while trying to locate/find a lost item (e.g., a pair of wireless earbuds), aspects presented herein may be used with (or applicable to) different types of devices. Instead of a phone acting as the “moving device” or the “tracking/finder device,” this role may also be played by any device that: (a) is able to move (or to be moved by a user), (b) is able to determine its own relative position and orientation as it moves, and (c) is able to measure the phase delay using two or more antennas. A non-exhaustive list of such devices may include: phones, tablets, or laptop computers, virtual reality (VR) headsets or augmented reality (AR) glasses, smart watches, or other types of wearable devices, robots or vehicles, toys. Similarly, instead of an earbud acting as the “lost item,” this role may be played by any device that: (a) is able to transmit wireless signals for ranging, and (b) is able to remain (mostly/nearly) static during the process. A non-exhaustive list of such devices may include: wireless headphones or earbuds, including their charging case, wireless tags, wireless stylus, Internet-of-Things (IoT) devices (such as smart thermostats, smart speakers, etc.), smart phones, tablets, laptop computers, cameras, VR headsets, AR glasses, smart watches, or other types of wearable devices, home appliances (dishwashers, refrigerators, etc.), alarms (smoke alarms, Carbon Monoxide alarms, etc.), toys, etc. Instead of using camera-based AR systems for determining the position of the “moving device,” some devices may use less accurate positioning mechanism, such as one or more accelerometers, gyroscopes, or magnetometers, etc.

In one aspect of the present disclosure, for a finder device with at least a pair of antennas that is capable of performing ranging and AoA measurements (e.g., a UE, a smartphone, the first device 502, the finder device 602, etc.), two coordinate systems centered around the finder device may be defined based on the followings:
(1) A Cartesian system with coordinates (x, y, z), with unit vectors aligned to the rectangular shape of the finder device.
(2) A spherical system with coordinates (r,θ,ϕ).

Both coordinate systems are related by the following transformation:

$$\begin{matrix}x = r \cdot sin ( ϕ ) \cdot cos ( θ ) \\ y = r \cdot sin ( ϕ ) \cdot sin ( θ ) \\ z = r \cdot cos ( ϕ )\end{matrix} \qquad ( 5 )$$

For simplicity of illustration, assuming that one of the antennas is at position \vec{x}=(x, y, z)=(0, 0, 0), while the other antenna is at \vec{a}=(aₓ, a_{y}, a_{z}). Note the antenna vector is not assumed to be aligned in any special direction, just that the antennas are physically attached to the phone and that they rotate with the finder device are assumed. It is also not assumed that the antenna has a length

$$‖ \vec{a} ‖ < \frac{λ}{2} .$$

Also, the definition of (θ,ϕ) used in the following examples (e.g., defined relative to finder device reference frame) may not be the same as the definition used in previous examples (e.g., defined relative to an antenna vector).

In one example, assuming the user of the finder device is trying to use the finder device to locate a target device that is static. While the finder device is performing ToF and PDoA measurements using one or more wireless radio(s) (e.g., Bluetooth, UWB, 802.11az, etc.), such as illustrated by FIG. 5, as the user moves the finder device, the finder device may use inputs from its camera and/or IMU to track its own pose (e.g., position and/plus orientation).

At each time tᵢ (with i∈{1, 2, . . . , N}), the following information may be available:
(1) The position of the phone: \vec{p}ᵢ.
(2) The orientation of the phone, expressed via unit vectors: \vec{u}ᵢ, \vec{v}ᵢ and \vec{w}ᵢ.
(3) The ToF distance measured from the finder device to the target device: rt.
(4) The PDoA measured by the antenna pair (for signals coming from the target device): ψᵢ.
(5) The standard deviation of the ToF measurement: σᵣ_{ᵢ}.
(6) The standard deviation of the PDoA measurement: σ_{ψ}_{ᵢ}.

For the algorithm described in this section, the absolute value of the difference between two possible PDoA values may often be evaluated. In some scenarios, PDoA may be a special type of magnitude, because (a) a given PDoA value may just take values in the range (−π, π], and (b) the absolute difference between two PDoA values may be specified to be in the range [0, π] (because the furthest apart that two angles can be from each other is 180°). Then, the following function is defined:

$$Δ ( x ) = \vert ( ( \vert x \vert + π ) mod ( 2 π ) ) - π \vert \qquad ( 6 )$$

That is, x is taken to compute its absolute value, add π, compute its value modulo 2π, subtract π, and finally compute its absolute value.

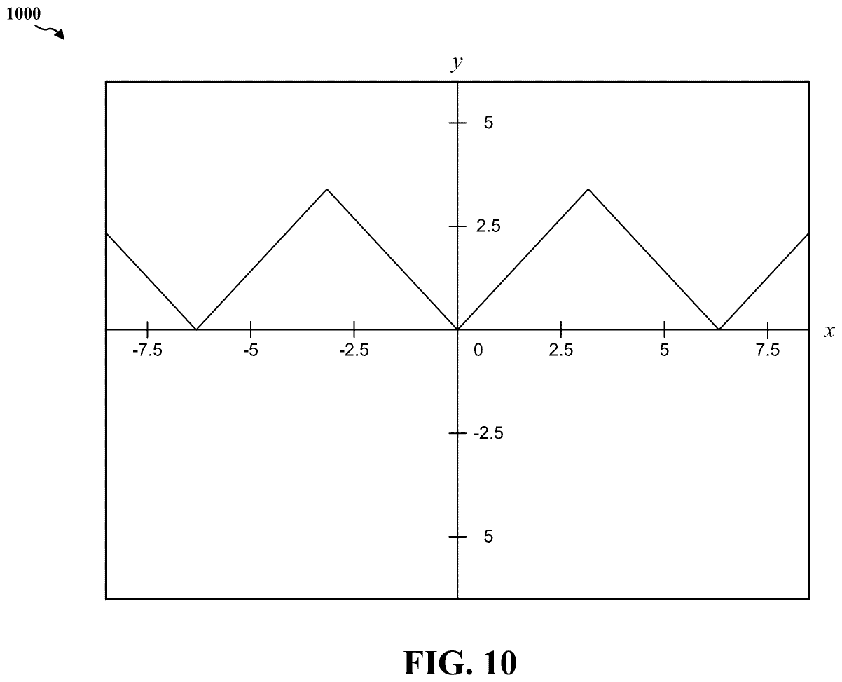

FIG. 10 is a diagram 1000 illustrating an example plot of function Δ(x) used to compute the difference between two PDoA values in accordance with various aspects of the present disclosure. For examples below, when computing the difference between two PDoA angles α and β, the notation Δ(α−β) may be used.

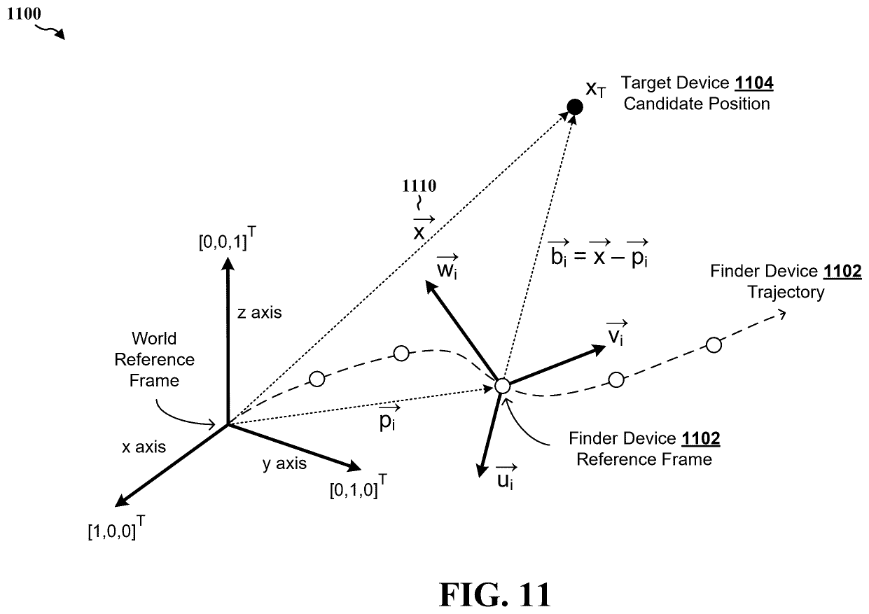

FIG. 11 is a diagram 1100 illustrating an example of reference frames in accordance with various aspects of the present disclosure. As shown at 1110, a finder device 1102 (e.g., a first UE, a smartphone, the first device 502, the finder device 602, etc.) may be configured to determine the likelihood of a target device 1104 (e.g., a second UE, a smartphone, the second device 504, the target device 604, etc.) at a certain position \vec{x}, given the information measured at sample i. Table 2 below is a list of auxiliary variables and functions that will be used in association with the diagram 1100 and the examples below.

TABLE 2
List of Auxiliary Variables and Functions

| Symbol | Description |
|---|---|
| i | Variable i ∈ {1, 2, ... , N} used to index measurements and variables |
| | corresponding to sample taken at time tᵢ. |
| rᵢ | Distance to target measured using TOF. |
| ψᵢ | PDoA measured at time tᵢ for RF signal coming from the target device |
| | 1104. |
| \vec{p}ᵢ | The measured position of the finder device 1102 at time tᵢ. |
| Uᵢ | A matrix whose columns are the unit vectors that represent the measured |
| | rotation of the finder device 1102. |
| \vec{u}ᵢ, \vec{v}ᵢ, \vec{w}ᵢ | The columns of matrix Uᵢ. |
| \vec{x} | A vector representing the candidate position for the target device 1104 |
| | in 3D space. |
| \vec{b}ᵢ | Defined as \vec{b}ᵢ = \vec{x} − \vec{p}ᵢ, this represents the vector between the finder |
| | device 1102 and the candidate position of target device 1104 at time tᵢ. |
| ρᵢ | Defined as ρᵢ = ∥ \vec{b}ᵢ∥ = ∥ \vec{x} − \vec{p}ᵢ∥, this represents the distance between |
| | the finder device 1102 and the candidate position for the target device |
| | 1104. |
| \vec{c}ᵢ | $Defined as {\vec{c}}_{i} = {U}_{i}^{T} \cdot {\vec{b}}_{i} , this represents the cartesian coordinates of the$ |
| | target device 1104 in the reference frame of the finder device 1102 |
| | (which is rotated). |
| \vec{s}ᵢ | Defined as a vector \vec{s}ᵢ = [ρᵢ, θᵢ, ϕᵢ]^{T}, this represents the spherical |
| | coordinates of the target device 1104 in the reference frame of the finder |
| | device 1102 (which is rotated). |
| q(\vec{c}ᵢ) | Function used to convert from Cartesian to spherical coordinates, with |
| | \vec{s}ᵢ = q(\vec{c}ᵢ). |
| g(θ, ϕ) | The function (obtained from calibration) that provides the PDoA value |
| | measured when an incoming signal arrives from azimuth |
| | θ and elevation ϕ relative to the finder device 1102 reference frame. |
| φᵢ | Defined as φᵢ = g(θᵢ, ϕᵢ), this is the hypothetical PDoA value that |
| | would be measured at time tᵢ if the target device 1104 was at candidate |
| | position \vec{x}. |

Using information from time tᵢ, the following loss function may be built:

$$\begin{matrix}{μ}_{i} ( \vec{x} ) = {μ}_{i}^{T o F} ( \vec{x} ) + {μ}_{i}^{P D o A} ( \vec{x} ) \\ = \frac{1}{2} {( \frac{{ρ}_{i} - {r}_{i}}{{σ}_{{r}_{i}}} )}^{2} + \frac{1}{2} {( \frac{Δ ( {φ}_{i} - {ψ}_{i} )}{{σ}_{{ψ}_{i}}} )}^{2} \\ = \frac{1}{2} {( \frac{{ρ}_{i} - {r}_{i}}{{σ}_{{r}_{i}}} )}^{2} + \frac{1}{2} {( \frac{Δ ( g ( {θ}_{i} , {ϕ}_{i} ) - {ψ}_{i} )}{{σ}_{{ψ}_{i}}} )}^{2} \\ = \frac{1}{2} {( \frac{‖ \vec{x} - {\vec{p}}_{i} ‖ - {r}_{i}}{{σ}_{{r}_{i}}} )}^{2} + \frac{1}{2} {( \frac{Δ ( g ( \vec{s} ) - {ψ}_{i} )}{{σ}_{{ψ}_{i}}} )}^{2} \\ = \frac{1}{2} {( \frac{‖ \vec{x} - {\vec{p}}_{i} ‖ - {r}_{i}}{{σ}_{{r}_{i}}} )}^{2} + \frac{1}{2} {( \frac{Δ ( g ( q ( \vec{c} ) ) - {ψ}_{i} )}{{σ}_{{ψ}_{i}}} )}^{2} \\ = \frac{1}{2} {( \frac{‖ \vec{x} - {\vec{p}}_{i} ‖ - {r}_{i}}{{σ}_{{r}_{i}}} )}^{2} + \frac{1}{2} {( \frac{Δ ( g ( q ( {U}_{i}^{T} \cdot {\vec{b}}_{i} ) ) - {ψ}_{i} )}{{σ}_{{ψ}_{i}}} )}^{2} \\ = \frac{1}{2} {( \frac{‖ \vec{x} - {\vec{p}}_{i} ‖ - {r}_{i}}{{σ}_{{r}_{i}}} )}^{2} + \frac{1}{2} {( \frac{Δ ( g ( q ( {U}_{i}^{T} \cdot ( \vec{x} - {\vec{p}}_{i} ) ) ) - {ψ}_{i} )}{{σ}_{{ψ}_{i}}} )}^{2}\end{matrix} \qquad ( 7 )$$

In some examples, the loss function may also be referred to as a “general function” that is capable of computing a probability that a target device 1104 is at a set of relative directions compared to the finder device 1102. The one remaining detail is describing function q(·): [symbol] ³→ [symbol] ³ used to transform a vector from cartesian coordinates to spherical coordinates.

$$\vec{s} = [ \begin{matrix}ρ \\ θ \\ ϕ\end{matrix} ] = q ( \vec{c} ) = q ( [ \begin{matrix}{c}_{x} \\ {c}_{y} \\ {c}_{z}\end{matrix} ] ) = [ \begin{matrix}‖ \vec{c} ‖ \\ arc tan 2 ( {c}_{y} , {c}_{x} ) \\ arc cos ( \frac{{c}_{z}}{‖ \vec{c} ‖} )\end{matrix} ] \qquad ( 8 )$$

where arctan 2 (y, x) is the 2-argument arctangent, that can produce a result in the full range (−π, π].

$$arc tan 2 ( y , x ) = \{ \begin{matrix}arc tan ( \frac{y}{x} ) & if & x > 0 \\ arc tan ( \frac{y}{x} ) + π & if & x < 0 , y \geq 0 \\ arc tan ( \frac{y}{x} ) - π & if & x < 0 , y < 0 \\ + \frac{π}{2} & if & x = 0 , y > 0 \\ - \frac{π}{2} & if & x = 0 , y < 0 \\ undefined & if & x = 0 , y = 0\end{matrix} \qquad ( 9 )$$

In summary, when computing the value of one term of the loss function for a candidate target device position x, the following steps may be performed:
1. The vector from the candidate target device position to the finder device position is determined (\vec{b}ᵢ=\vec{x}−\vec{p}ᵢ).
2. \vec{b}ᵢ is transformed into the reference frame of the rotated finder device

$$1102 ( {\vec{c}}_{i} = {U}_{i}^{T} \cdot {\vec{b}}_{i} ) .$$

3. \vec{c}ᵢ is converted from Cartesian to spherical coordinates (\vec{s}ᵢ=[ρᵢ, θᵢ, ϕᵢ]^{T}=q(\vec{c}ᵢ)).
4. (θᵢ, ϕᵢ) is inputted into function g(·) to determine the hypothetical PDoA that may be generated by the candidate target device position (φᵢ=g(θᵢ, ϕᵢ)).
5. Now both ρᵢ (hypothetical distance to candidate target device position) and φᵢ (hypothetical PDoA for candidate target position) are available.
6. ρᵢ is compared with rᵢ (to obtain the TOF term for the loss function) and φᵢ is compared with ψᵢ (to obtain the PDoA term for the loss function).
7. The result is a loss function term μᵢ(\vec{x}) that takes small values if ρᵢ is similar to rᵢ and φᵢ is similar to ψᵢ, and large values otherwise.

The loss function may also be applied to multiple (N) samples. For example, to include the information from all samples, all N terms may be added to the loss function:

$$μ ( \vec{x} ) = {\sum }_{i = 1}^{N} {μ}_{i} ( \vec{x} ) \qquad ( 10 )$$

The above equation from the loss function may also be extended to include the case in which more than two (2) antennas are available for measuring PDoA. For example, if a third antenna is available, two different PDoA angles ψ^{a} and ψ^{b} can be measured. Each one may be approximated by a different g(·) function:

$$\begin{matrix}{ψ}^{a} = {g}^{a} ( θ , ϕ ) & {ψ}^{b} = {g}^{b} ( θ , ϕ )\end{matrix} \qquad ( 11 )$$

and the extended loss function is now:

$$\begin{matrix}μ ( \vec{x} ) = {\sum }_{i = 1}^{N} \{ {μ}_{i}^{T o F} ( \vec{x} ) + {μ}_{i}^{P D o A} ( \vec{x} ) \} \\ = {\sum }_{i = 1}^{N} \{ \frac{1}{2} {( \frac{{ρ}_{i} - {r}_{i}}{{σ}_{{r}_{i}}} )}^{2} + \frac{1}{2} {( \frac{Δ ( {g}^{a} ( {θ}_{i} , {ϕ}_{i} ) - {ψ}_{i}^{a} )}{{σ}_{{ψ}_{i}^{a}}} )}^{2} + \frac{1}{2} {( \frac{Δ ( {g}^{b} ( {θ}_{i} , {ϕ}_{i} ) - {ψ}_{i}^{b} )}{{σ}_{{ψ}_{i}^{b}}} )}^{2} \}\end{matrix} \qquad ( 12 )$$

In some scenarios, such as in a real application, it is possible that some of the terms of the loss function may be missing. For example, if for a certain j there is no TOF measurement for rⱼ, then the j-th term may not be included for the μ^{ToF}(\vec{x}) function. Or if for a certain k there is no PDoA measurement for ψₖ, then the k-th term may not be included for the μ^{PDoA}(\vec{x}) function.

Based on the above equations, the position \vec{x}_{T} of the target device 1104 may be determined/estimated by finding the point \vec{x} that minimizes the loss function:

$${\vec{x}}_{T} = {arg min}_{\vec{x}} \{ μ ( \vec{x} ) \} = {arg min}_{\vec{x}} \{ {\sum }_{i = 1}^{N} \{ {μ}_{i}^{T o F} ( \vec{x} ) + {μ}_{i}^{P D o A} ( \vec{x} ) \} \} \qquad ( 13 )$$

In some examples, as the PDoA function g(θ,ϕ) is not bijective, the loss function μ(\vec{x}) may have a local minima. So, a typical gradient descent algorithm may get stuck in one of them. A robust implementation may be specified to use some mechanisms for minimizing in the presence of local minima, such as using the gradient descent with genetic algorithm (GD-GA).

GD-GA may refer to a technique that is capable of combining genetic algorithms with gradient descent (GD). While other techniques may also be possible, for purposes of the present disclosure, an extension of GD with techniques from genetic algorithms is implemented to avoid the problem of GD getting stuck on local minima.

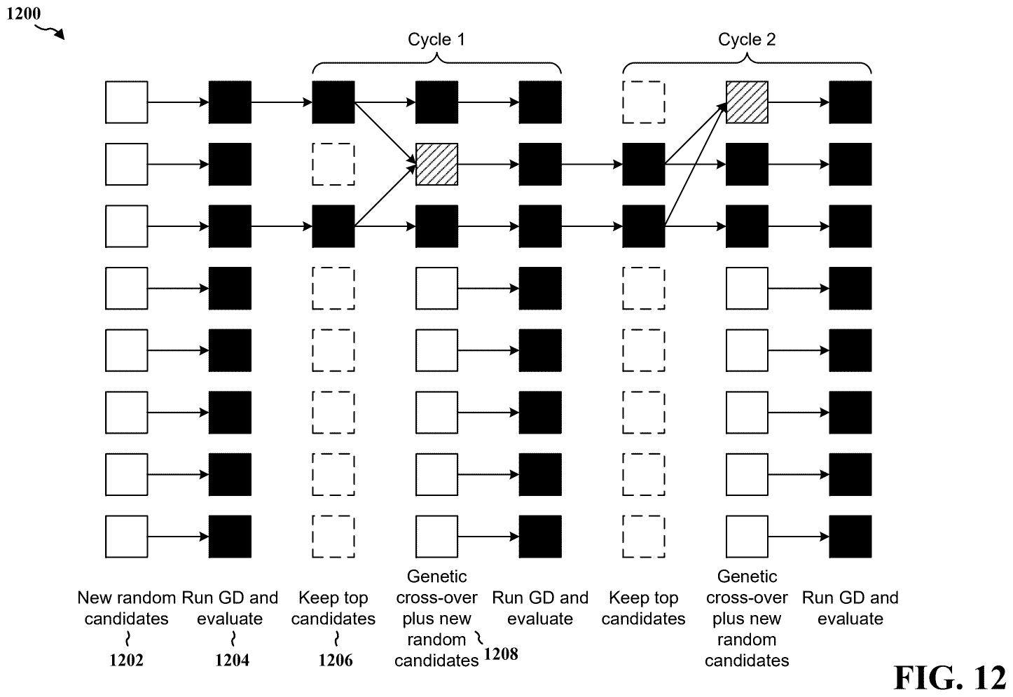

FIG. 12 is a diagram 1200 illustrating an example graphical description of a GD-GA algorithm in accordance with various aspects of the present disclosure. The diagram 1200 provides a graphical representation of how the combined algorithm may operate.

As shown at 1202 (e.g., a first step), a pool of candidate solutions with initial random positions \vec{x} is generated. In this example, the size of the pool of candidates is eight (e.g., G=8).

As shown at 1204 (e.g., a second step), the gradient descent (GD) may be configured to run for some predefined number of iterations (K) with all candidates, and keep track of both the new positions \vec{x} and the value μ(\vec{x}) of each candidate.

As shown at 1206 (e.g., a third step), a small number F of candidate solutions (e.g., the ones with the smallest value of μ(\vec{x})) is selected and the rest is discarded. In this example F=2. The set of selected candidates may be referred to as the “survival set.”

As shown at 1208 (e.g., a fourth step), new child candidates are created based on descending from the candidates that survived in the previous step. The value \vec{x} of the child is the average of the \vec{x} of the parents. In this example, as there are just two parents, so there is one child. In general, with F surviving parents, there are

$$\frac{F ( F - 1 )}{2}$$

children. Then, if the number of remaining solutions (parents plus children) is less than G, extra random candidate solutions may be added until the pool is completed.

The process described in connection with 1204, 1206, and 1208 (e.g., steps 2, 3 and 4) may be repeated until a stop condition is met (discussed below). The above algorithm may be referred to as the “genetic algorithm” because of its similarities with several biological mechanisms. For example, solutions are evaluated for fitness, and just those with the best fitness survive and pass to the next generation. Pairs of solutions with good fitness are used to breed new solutions with genes that are a combination of the parents' genes. In this case the genes are the value of x and the recombination process is just an averaging process). Fitness-improving mutations are added by the gradient descent process on each candidate. Random mutations are introduced to the gene pool by adding some random solutions in each cycle.

One possible risk in the algorithm described in connection with FIG. 11 is that sometimes there may be two surviving candidates that are too similar to each other because both are converging to the same local minimum. In that case, there may be little value in keeping both candidates and then crossing them to get a new child that is the average of both. It may be a waste of computing resources running gradient descent on three candidates that are the same candidate.

In one aspect of the present disclosure, to solve this problem, the algorithm described in connection with FIG. 11 may be modified by adding a “diversity specification/condition” when selecting candidates for survival: for each pair of candidates in the pool, their “diversity index” (by basically computing their Euclidian distance), and then candidates that are too close to other candidates already in the survival set may be discarded. Specifically, a “Diversity Radius” R may be specified, and just one candidate \vec{x}ⱼ for survival is selected if its diversity index dⱼₙ=∥\vec{x}ⱼ−\vec{x}ₙ∥>R, for all n already in the survival set.

Then, the following sub-algorithm may be used as a replacement for 1206 (e.g., the third step) of the generic algorithm described in connection with FIG. 11:
1. εₖ:={1, . . . , G} is the set of indices for candidate solutions at step k in the genetic algorithm.
2. Sₖ:=Ø is the set of indices for surviving solution at step k, which is initialized as an empty set.
3. μ(\vec{x}ᵢ) is evaluated for each candidate xᵢ, with i∈εₖ.
4. The index j is selected for the candidate with the lowest value of μ( ), that is j=argmin_{i∈ε}_{ₖ}{μ(\vec{x}ᵢ)}
5. Index j is removed from εₖ.
6. dⱼₙ=∥\vec{x}ⱼ−xₙ∥ is computed for all n∈Sₖ.
7. If dⱼₙ>R for all n∈Sₖ, then j is added to Sₖ.
8. If εₖ≠Ø and |Sₖ|<F, then go back to 1208 (e.g., the fourth step). Otherwise, the algorithm ends and Sₖ now contains the indices of all surviving candidates.

It may be noted that the above algorithm may not guarantee that exactly F candidates will survive. For example, there may be cases in which all candidates were too close to each other, in which case just one of the candidates may survive to the next generation.

In some implementations, it may be suitable to stop the genetic algorithm when either one of the following two conditions are met: (1) some candidates keep being selected as the best solution across B generations in a row; or (2) the total number of generations exceed some pre-specified maximum M.

Table 3 below provides a summary of parameters for the GA-GD algorithm described above that can be used to customize operation of the GA-GD algorithm.

TABLE 3
Summary of Parameters for GA-GD Algorithm

| | |
|---|---|
| G | Number of candidates in the pool in each |
| | generation. |
| F | Maximum number of candidates in the survival set |
| | in each generation. |
| R | Diversity radius. |
| B | Number of times the same solution is the best |
| | solution before we conclude GA-GD algorithm. |
| M | Maximum number of generations in GA-GD |
| | algorithm. |
| K | Number of iterations of Gradient Descent to run on |
| | each candidate in each generation. |

In some scenarios, the finder device 1102 may be specified to decide when it has collected enough samples that it has enough information to compute an estimate of the position of the target device 1104. At this point the finder device 1102 (e.g., a smartphone) may be configured to start displaying the location information to the user, or providing a direction for the user to walk as described in connection with FIG. 6.

In one aspect of the present disclosure, the finder device 1102 may be configured to apply the following mechanisms:
1. The finder device 1102 starts collecting data {\vec{p}ᵢ}, {rᵢ}, {ψᵢ}.
2. The finder device 1102 builds the loss function described in Equation (10)

$$( i . e . , μ ( \vec{x} ) = {\sum }_{i = 1}^{N} {μ}_{i} ( \vec{x} ) ) .$$

3. The finder device 1102 uses the minimization algorithm discussed in connection with Equation (13)

$$( i . e . , {\vec{x}}_{T} = {arg min}_{\vec{x}} \{ μ ( \vec{x} ) \} = {arg min}_{\vec{x}} \{ {\sum }_{i = 1}^{N} \{ {μ}_{i}^{T o F} ( \vec{x} ) + {μ}_{i}^{P D o A} ( \vec{x} ) \} \} )$$

(potentially include the GA-GD technique above) to determine the target location \vec{x}₀.
4. The finder device 1102 computes the value of ∇²μ(\vec{x}₀) (e.g., using a numerical method or an exact method).
5. If there is an absolute precision target:
   (a) The finder device 1102 determines the eigenvalues of ∇²μ(\vec{x}₀), which may be referred to as αᵢ for i∈{1, 2, 3}.
   (b) The finder device 1102 computes

$${σ}_{i} = \frac{1}{\sqrt{{α}_{i}}} .$$

(c) If all values of σᵢ are smaller than the absolute precision target, then the finder device 1102 starts displaying location information to the user.
6. If there is a directional precision target:
   (a) The finder device 1102 determines the absolute precision in the horizontal direction.
   (b) The finder device 1102 divides the absolute precision by the target distance to get the directional precision.
   (c) If the directional precision is smaller than the target device 1104, then the finder device 1102 starts displaying location information to the user.

In some implementation, as the finder device 1102 may be specified to collect the data {\vec{p}ᵢ}, {rᵢ}, {ψᵢ} from a plurality of orientations and/or positions (e.g., i orientations and/or positions), the finder device 1102 may be configured to output a request to rotate the finder device 1102, such as when the finder device 1102 detects that the finder device 1102 is static. Then, the finder device 1102 may start to track the plurality of orientations when the finder device 1102 is rotating and/or moving. For example, when a user of the finder device 1102 (e.g., a mobile phone) is trying to find the direction to a target, the finder device 1102 (or an application/software running on the finder device 1102) may be configured to instruct the user to rotate and/or move the finder device 1102 (while the finder device 1102 track its own movements such as using a camera, an accelerometer, a gyroscope, a magnetometer, an IMU, etc.), such that the wireless device is able to make PDoA measurements from different orientations (and/or positions). In addition, the finder device 1102 may include a user interface (UI) that enables the finder device 1102 to provide, at/via the UI, at least one of (1) a guidance for rotating the finder device 1102, (2) a guidance for rotating the finder device 1102 from a current orientation to an orientation within a plurality of orientations, and/or (3) a guidance for moving the finder device 1102 towards a direction, such as described in connection with FIG. 6. In some examples, the UI may include a graphical user interface (GUI) configured to display a graphical icon that is configured to rotate as the finder device 1102 is rotated and/or a graphical icon that is configured to move as the finder device 1102 is moved.

Aspects presented herein may improve the overall cost of wireless tracking and ranging by enabling a wireless device to perform AoA determination using non-ideal and non-directional antennas. Aspects presented herein may enable wireless devices (e.g., mobile phones) that may or may not use dedicated AoA antennas to perform AoA estimations even if the antennas have a non-ideal pattern. For example, in one aspect, an AoA calibration process characterizes the PDoA function for a pair of antennas in a UE, and then uses this calibration information (plus information coming from sensors) to determine the position of a target device.

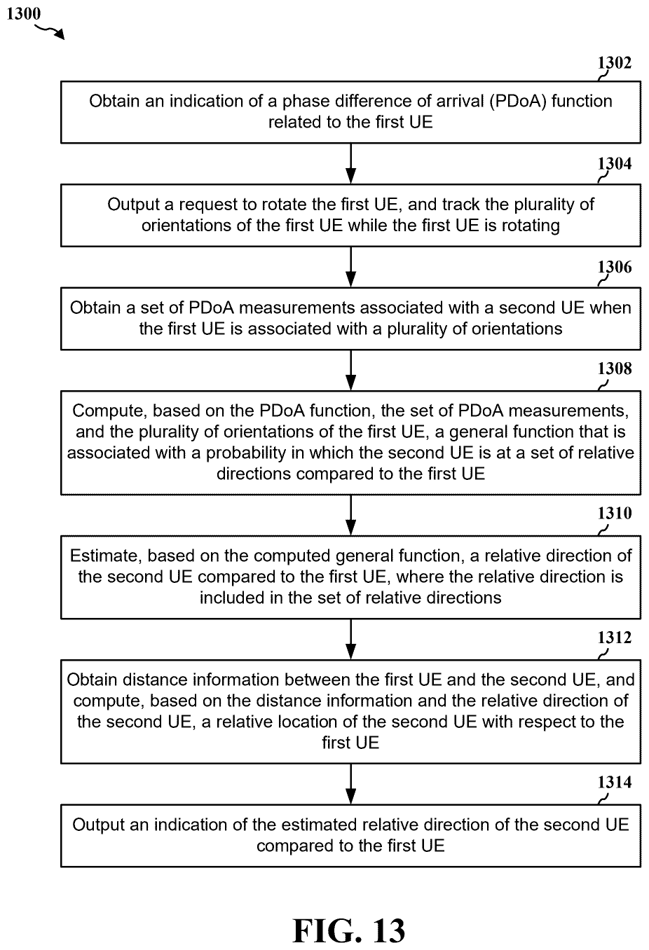

FIG. 13 is a flowchart 1300 of wireless communication at a user equipment (UE). The method may be performed by a first UE (e.g., the UE 104, 404; the first device 502; the finder device 602, 1102; the apparatus 1504). The method may enable the first UE to perform AoA determination using non-ideal and non-directional antennas. For purposes of the present disclosure, a UE may refer to any wireless devices, including and is not limited to, mobile devices, access points, wireless radios in a vehicle, smart appliances with wireless radios, consumer electronics with wireless radios, IoT devices, etc.

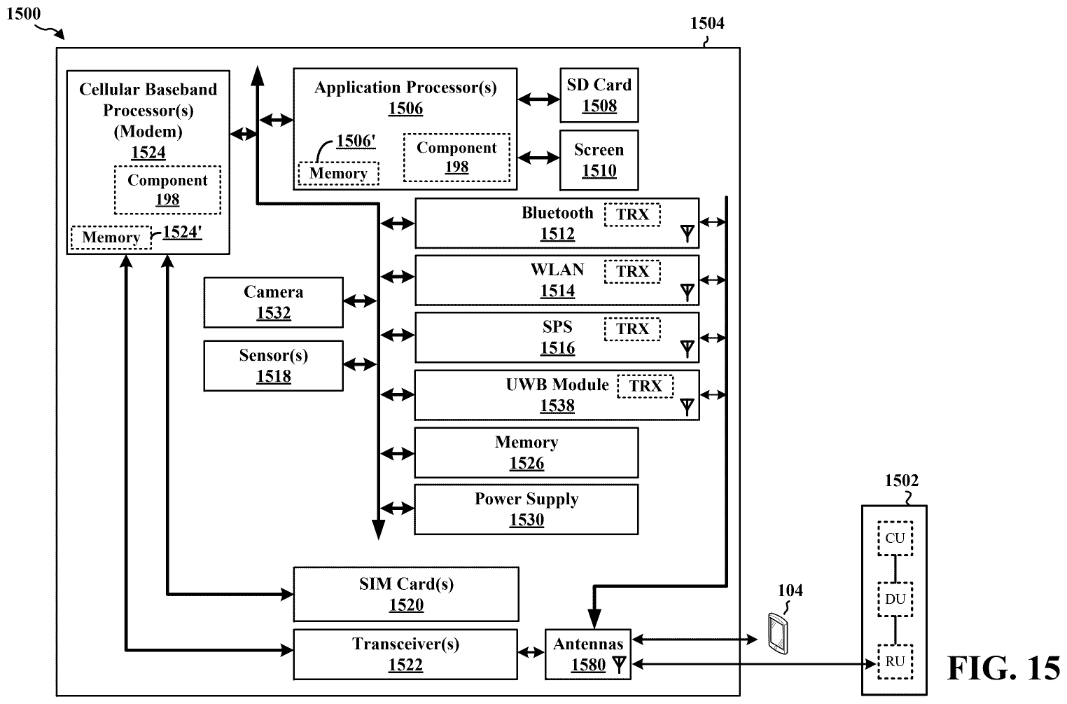

At 1302, the first UE may obtain an indication of a PDoA function related to the first UE. For example, as described above or in connection with FIG. 11, a tracking/finder device (e.g., the first device 502, the finder device 602, a mobile phone, a UE, etc.) may be configured to obtain a PDoA function (e.g., g(θ,ϕ)) related to the tracking/finder device. The obtainment of the indication may be performed by, e.g., the tracking component 198, the one or more sensors 1518, the transceiver(s) 1522, the cellular baseband processor(s) 1524, and/or the application processor(s) 1506 of the apparatus 1504 in FIG. 15.

In one example, the PDoA function is a function g(θ,ϕ) that calculates an ideal or hypothetical PDoA value for a signal from a given set of points (θ,ϕ), where θ is azimuth and ϕ is elevation. In some examples, the AoA is a variable (e.g., variable θ) of the PDoA function.

In another example, the PDoA function related to the first UE is associated with Bluetooth® ranging, Wi-Fi® ranging, or ultra-wideband (UWB) ranging.

In another example, to obtain the indication of the PDoA function, the first UE may be configured to at least one of: obtain the indication of the PDoA function via a calibration process, obtain the indication based on a lookup table (LUT), receive the indication from another device or a network entity, or obtain the indication based on a pre-configuration.

At 1306, the first UE may obtain a set of PDoA measurements associated with a second UE when the first UE is associated with a plurality of orientations. For example, as described above or in connection with FIG. 11, assuming the user of the finder device is trying to use the finder device to locate a static target device. While the finder device is performing ToF and PDoA measurements using some wireless radio(s) (e.g., Bluetooth, UWB, 802.11az, etc.). At each time tᵢ (with i∈{1, 2, . . . , N}), the following information may be available: . . . (4) The PDoA measured by the antenna pair (for signals coming from the target device): ψᵢ . . . (6) The standard deviation of the PDoA measurement: σ_{ψ}_{ᵢ}. The obtainment of the set of PDoA measurements may be performed by, e.g., the tracking component 198, the one or more sensors 1518, the transceiver(s) 1522, the cellular baseband processor(s) 1524, and/or the application processor(s) 1506 of the apparatus 1504 in FIG. 15.

In one example, to obtain the set of PDoA measurements associated with the second UE when the first UE is associated with the plurality of orientations, the first UE may be configured to receive, from the second UE, a set of signals at each orientation of the plurality of orientations, and measure a PDoA of the set of signals at each orientation of the plurality of orientations to obtain the set of PDoA measurements associated with the second UE. In some implementations, to receive the set of signals, the first UE may be configured to receive the set of signals via at least two antennas.

At 1308, the first UE may compute, based on the PDoA function, the set of PDoA measurements, and the plurality of orientations of the first UE, a general function that is associated with a probability in which the second UE is at a set of relative directions compared to the first UE. For example, as described above or in connection with FIG. 11, the finder device 1102 (e.g., a first UE, a smartphone, the first device 502, the finder device 602, etc.) may be configured to determine the likelihood of a target device 1104 (e.g., a second UE, a smartphone, the second device 504, the target device 604, etc.) at a certain position \vec{x}, given the information measured at sample i. For example, using information from time tᵢ, the following loss function may be built:

$${μ}_{i} ( \vec{x} ) = {μ}_{i}^{T o F} ( \vec{x} ) + {μ}_{i}^{P D o A} ( \vec{x} ) .$$

In some examples, the loss function may also be referred to as a “general function” that is capable of computing a probability in a target device 1104 is at a set of relative directions compared to the finder device 1102. The computation of the general function may be performed by, e.g., the tracking component 198, the one or more sensors 1518, the transceiver(s) 1522, the cellular baseband processor(s) 1524, and/or the application processor(s) 1506 of the apparatus 1504 in FIG. 15.

In one example, to compute the general function that is associated with the probability in which the second UE is at the set of relative directions compared to the first UE, the first UE may be configured to constrain possible values for the PDoA function based on the set of PDoA measurements and the plurality of orientations of the first UE, and build, based on the constrained possible values for the PDoA function, the general function that indicates a mismatch between the set of PDoA measurements and a set of hypothetical PDoA measurements from the PDoA function for a given candidate pair of points.

At 1310, the first UE may estimate, based on the computed general function, a relative direction of the second UE compared to the first UE, where the relative direction is included in the set of relative directions. For example, as described above or in connection with FIG. 11, based on the above equations, the position \vec{x}_{T} of the target device 1104 may be determined/estimated by finding the point \vec{x} that minimizes the loss function:

$${\vec{x}}_{T} = {arg min}_{\vec{x}} \{ μ ( \vec{x} ) \} = {arg min}_{\vec{x}} \{ {\sum }_{i = 1}^{N} \{ {μ}_{i}^{T o F} ( \vec{x} ) + {μ}_{i}^{P D o A} ( \vec{x} ) \} \} .$$

The estimation of the relative direction of the second UE compared to the first UE may be performed by, e.g., the tracking component 198, the one or more sensors 1518, the transceiver(s) 1522, the cellular baseband processor(s) 1524, and/or the application processor(s) 1506 of the apparatus 1504 in FIG. 15.

In one example, to estimate, based on the computed general function, the relative direction of the second UE compared to the first UE, the first UE may be configured to determine, based on the computed general function, a set of points that provides a highest probability in which the second UE is at the set of points, and calculate, based on the set of points, the relative direction of the second UE compared to the first UE. In some implementations, to determine the set of points that provides the highest probability in which the second UE is at the set of points, the first UE may be configured to use at least one minimization technique to find the set of points that achieves a minimum value for the computed general function. In some implementations, the at least one minimization technique includes gradient descent (GD) or a generic algorithm with gradient descent (GA-GD).

In another example, as shown at 1304, the first UE may output a request to rotate the first UE, and track the plurality of orientations of the first UE while the first UE is rotating. For example, as described above or in connection with FIG. 11, when a user of the wireless device is trying to find the direction to the target, the wireless device (or an application/software running on the wireless device) may be configured to instruct the user to rotate and/or move the wireless device (while the wireless device tracks its own movements such as using a camera, an accelerometer, a gyroscope, a magnetometer, an IMU, etc.), such that the wireless device is able to make PDoA measurements from different orientations (and/or positions). The output of the request may be performed by, e.g., the tracking component 198, the one or more sensors 1518, the transceiver(s) 1522, the cellular baseband processor(s) 1524, and/or the application processor(s) 1506 of the apparatus 1504 in FIG. 15. In some implementations, to track the plurality of orientations of the first UE, the first UE may be configured to track the plurality of orientations of the first UE using at least one inertial measurement unit (IMU), at least one camera, or a combination thereof.

In another example, as shown at 1312, the first UE may obtain distance information between the first UE and the second UE, and compute, based on the distance information and the relative direction of the second UE, a relative location of the second UE with respect to the first UE. For example, as described above or in connection with FIG. 5, based on the time-of-flight (ToF) of the Tx signals and the Rx signals, the first device 502 may estimate the distance of the second device 504 from the first device 502. In some configurations, if the first device is also capable of measuring the angle-of-arrival (AoA) of the Rx signals, the first device 502 may also be able to estimate the direction of the second device 504 from the first device 502 (which may be referred to as the relative direction from the first device 502). The obtainment of the distance information and/or the computation of the relative location of the second UE may be performed by, e.g., the tracking component 198, the one or more sensors 1518, the transceiver(s) 1522, the cellular baseband processor(s) 1524, and/or the application processor(s) 1506 of the apparatus 1504 in FIG. 15.

In another example, as shown at 1314, the first UE may output an indication of the estimated relative direction of the second UE compared to the first UE. For example, as described above or in connection with FIG. 6, a finder device 602 (e.g., a mobile phone) or an application running on the finder device 602 may instruct the user (e.g., via a user interface (UI)) to select an item (e.g., from a list of detected items) for tracking/locating. The output of the indication may be performed by, e.g., the tracking component 198, the one or more sensors 1518, the transceiver(s) 1522, the cellular baseband processor(s) 1524, and/or the application processor(s) 1506 of the apparatus 1504 in FIG. 15. In some implementations, to output the indication of the estimated relative direction of the second UE compared to the first UE, the first UE may be configured to transmit the indication of the estimated relative direction of the second UE compared to the first UE, display the indication via a screen or a user interface, or store the indication of the estimated relative direction of the second UE compared to the first UE.

In another example, the first UE may display, via a user interface (UI), the computed relative direction of the second UE with respect to the first UE. In some implementations, the first UE may further display a distance of the second UE from the first UE, and/or an image or a description of the second UE.

In another example, the first UE may provide, at a user interface (UI), at least one of (1) a first guidance for rotating the first UE, (2) a second guidance for rotating the first UE from a current orientation to an orientation within the plurality of orientations, or (3) a third guidance for moving the first UE towards a direction. In some implementations, the UI may include a graphical user interface (GUI) configured to display a first graphical icon that is configured to rotate as the first UE is rotated or a second graphical icon that is configured to move as the first UE is moved.

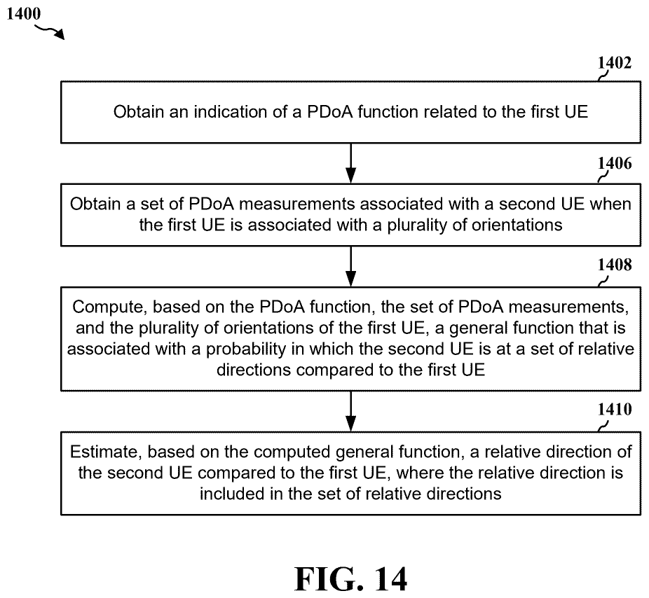

FIG. 14 is a flowchart 1400 of wireless communication at a user equipment (UE). The method may be performed by a first UE (e.g., the UE 104, 404; the first device 502; the finder device 602, 1102; the apparatus 1504). The method may enable the first UE to perform AoA determination using non-ideal and non-directional antennas. For purposes of the present disclosure, a UE may refer to any wireless devices, including and is not limited to, mobile devices, access points, wireless radios in a vehicle, smart appliances with wireless radios, consumer electronics with wireless radios, IoT devices, etc.

At 1402, the first UE may obtain an indication of a PDoA function related to the first UE. For example, as described above or in connection with FIG. 11, a tracking/finder device (e.g., the first device 502, the finder device 602, a mobile phone, a UE, etc.) may be configured to obtain a PDoA function (e.g., g(θ,ϕ)) related to the tracking/finder device. The obtainment of the indication may be performed by, e.g., the tracking component 198, the one or more sensors 1518, the transceiver(s) 1522, the cellular baseband processor(s) 1524, and/or the application processor(s) 1506 of the apparatus 1504 in FIG. 15.

In one example, the PDoA function is a function g(θ,ϕ) that calculates an ideal or hypothetical PDoA value for a signal from a given set of points (θ,ϕ), where θ is azimuth and ϕ is elevation.

In another example, the PDoA function related to the first UE is associated with Bluetooth® ranging, Wi-Fi® ranging, or UWB ranging.

In another example, to obtain the indication of the PDoA function, the first UE may be configured to at least one of: obtain the indication of the PDoA function via a calibration process, obtain the indication based on a LUT, receive the indication from another device or a network entity, or obtain the indication based on a pre-configuration.

At 1406, the first UE may obtain a set of PDoA measurements associated with a second UE when the first UE is associated with a plurality of orientations. For example, as described above or in connection with FIG. 11, assuming the user of the finder device is trying to use the finder device to locate a static target device. While the finder device is performing ToF and PDoA measurements using some wireless radio(s) (e.g., Bluetooth, UWB, 802.11az, etc.). At each time tᵢ (with i∈{1, 2, . . . , N}), the following information may be available: . . . (4) The PDoA measured by the antenna pair (for signals coming from the target device): ψᵢ . . . (6) The standard deviation of the PDoA measurement: σ_{ψ}_{ᵢ}. The obtainment of the set of PDoA measurements may be performed by, e.g., the tracking component 198, the one or more sensors 1518, the transceiver(s) 1522, the cellular baseband processor(s) 1524, and/or the application processor(s) 1506 of the apparatus 1504 in FIG. 15.

In one example, to obtain the set of PDoA measurements associated with the second UE when the first UE is associated with the plurality of orientations, the first UE may be configured to receive, from the second UE, a set of signals at each orientation of the plurality of orientations, and measure a PDoA of the set of signals at each orientation of the plurality of orientations to obtain the set of PDoA measurements associated with the second UE. In some implementations, to receive the set of signals, the first UE may be configured to receive the set of signals via at least two antennas.

At 1408, the first UE may compute, based on the PDoA function, the set of PDoA measurements, and the plurality of orientations of the first UE, a general function that is associated with a probability in which the second UE is at a set of relative directions compared to the first UE. For example, as described above or in connection with FIG. 11, the finder device 1102 (e.g., a first UE, a smartphone, the first device 502, the finder device 602, etc.) may be configured to determine the likelihood of a target device 1104 (e.g., a second UE, a smartphone, the second device 504, the target device 604, etc.) at a certain position x, given the information measured at sample i. For example, using information from time t₁, the following loss function may be built:

$${μ}_{i} ( \vec{x} ) = {μ}_{i}^{T o F} ( \vec{x} ) + {μ}_{i}^{P D o A} ( \vec{x} ) .$$

In some examples, the loss function may also be referred to as a “general function” that is capable of computing a probability in a target device 1104 is at a set of relative directions compared to the finder device 1102. The computation of the general function may be performed by, e.g., the tracking component 198, the one or more sensors 1518, the transceiver(s) 1522, the cellular baseband processor(s) 1524, and/or the application processor(s) 1506 of the apparatus 1504 in FIG. 15.

In one example, to compute the general function that is associated with the probability in which the second UE is at the set of relative directions compared to the first UE, the first UE may be configured to constrain possible values for the PDoA function based on the set of PDoA measurements and the plurality of orientations of the first UE, and build, based on the constrained possible values for the PDoA function, the general function that indicates a mismatch between the set of PDoA measurements and a set of hypothetical PDoA measurements from the PDoA function for a given candidate pair of points.

At 1410, the first UE may estimate, based on the computed general function, a relative direction of the second UE compared to the first UE, where the relative direction is included in the set of relative directions. For example, as described above or in connection with FIG. 11, based on the above equations, the position \vec{x}ᵣ of the target device 1104 may be determined/estimated by finding the point \vec{x} that minimizes the loss function:

$${\vec{x}}_{T} = {arg min}_{\vec{x}} \{ μ ( \vec{x} ) \} = {arg min}_{\vec{x}} \{ {\sum }_{i = 1}^{N} \{ {μ}_{i}^{T o F} ( \vec{x} ) + {μ}_{i}^{P D o A} ( \vec{x} ) \} \} .$$

The estimation of the relative direction of the second UE compared to the first UE may be performed by, e.g., the tracking component 198, the one or more sensors 1518, the transceiver(s) 1522, the cellular baseband processor(s) 1524, and/or the application processor(s) 1506 of the apparatus 1504 in FIG. 15.

In one example, to estimate, based on the computed general function, the relative direction of the second UE compared to the first UE, the first UE may be configured to determine, based on the computed general function, a set of points that provides a highest probability in which the second UE is at the set of points, and calculate, based on the set of points, the relative direction of the second UE compared to the first UE. In some implementations, to determine the set of points that provides the highest probability in which the second UE is at the set of points, the first UE may be configured to use at least one minimization technique to find the set of points that achieves a minimum value for the computed general function. In some implementations, the at least one minimization technique includes a GD or a GA-GD.

In another example, the first UE may output a request to rotate the first UE, and track the plurality of orientations of the first UE while the first UE is rotating. For example, as described above or in connection with FIG. 11, when a user of the wireless device is trying to find the direction to the target, the wireless device (or an application/software running on the wireless device) may be configured to instruct the user to rotate and/or move the wireless device (while the wireless device tracks its own movements such as using a camera, an accelerometer, a gyroscope, a magnetometer, an IMU, etc.), such that the wireless device is able to make PDoA measurements from different orientations (and/or positions). The output of the request may be performed by, e.g., the tracking component 198, the one or more sensors 1518, the transceiver(s) 1522, the cellular baseband processor(s) 1524, and/or the application processor(s) 1506 of the apparatus 1504 in FIG. 15. In some implementations, to track the plurality of orientations of the first UE, the first UE may be configured to track the plurality of orientations of the first UE using at least one IMU, at least one camera, or a combination thereof.

In another example, the first UE may obtain distance information between the first UE and the second UE, and compute, based on the distance information and the relative direction of the second UE, a relative location of the second UE with respect to the first UE. For example, as described above or in connection with FIG. 5, based on the ToF of the Tx signals and the Rx signals, the first device 502 may estimate the distance of the second device 504 from the first device 502. In some configurations, if the first device is also capable of measuring the AoA of the Rx signals, the first device 502 may also be able to estimate the direction of the second device 504 from the first device 502 (which may be referred to as the relative direction from the first device 502). The obtainment of the distance information and/or the computation of the relative location of the second UE may be performed by, e.g., the tracking component 198, the one or more sensors 1518, the transceiver(s) 1522, the cellular baseband processor(s) 1524, and/or the application processor(s) 1506 of the apparatus 1504 in FIG. 15.

In another example, the first UE may output an indication of the estimated relative direction of the second UE compared to the first UE. For example, as described above or in connection with FIG. 6, a finder device 602 (e.g., a mobile phone) or an application running on the finder device 602 may instruct the user (e.g., via a UI) to select an item (e.g., from a list of detected items) for tracking/locating. The output of the indication may be performed by, e.g., the tracking component 198, the one or more sensors 1518, the transceiver(s) 1522, the cellular baseband processor(s) 1524, and/or the application processor(s) 1506 of the apparatus 1504 in FIG. 15. In some implementations, to track the plurality of orientations of the first UE, the first UE may be configured to track the plurality of orientations of the first UE using at least one IMU, at least one camera, or a combination thereof. In some implementations, to output the indication of the estimated relative direction of the second UE compared to the first UE, the first UE may be configured to transmit the indication of the estimated relative direction of the second UE compared to the first UE, display the indication via a screen or a user interface, or store the indication of the estimated relative direction of the second UE compared to the first UE.

In another example, the first UE may display, via a UI, the computed relative direction of the second UE with respect to the first UE. In some implementations, the first UE may further display a distance of the second UE from the first UE, and/or an image or a description of the second UE.

In another example, the first UE may provide, at a user interface (UI), at least one of (1) a first guidance for rotating the first UE, (2) a second guidance for rotating the first UE from a current orientation to an orientation within the plurality of orientations, or (3) a third guidance for moving the first UE towards a direction. In some implementations, the UI may include a graphical user interface (GUI) configured to display a first graphical icon that is configured to rotate as the first UE is rotated or a second graphical icon that is configured to move as the first UE is moved.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an ultrawide band (UWB) module 1538 (e.g., a UWB transceiver), an SPS module 1516 (e.g., GNSS module), one or more sensors 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the UWB module 1538, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1506 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the tracking component 198 may be configured to obtain an indication of a PDoA function related to the first UE. The tracking component 198 may also be configured to obtain a set of PDoA measurements associated with a second UE when the first UE is associated with a plurality of orientations. The tracking component 198 may also be configured to compute, based on the PDoA function, the set of PDoA measurements, and the plurality of orientations of the first UE, a general function that is associated with a probability in which the second UE is at a set of relative directions compared to the first UE. The tracking component 198 may also be configured to estimate, based on the computed general function, a relative direction of the second UE compared to the first UE, where the relative direction is included in the set of relative directions. The tracking component 198 may be within the cellular baseband processor(s) 1524, the application processor(s) 1506, or both the cellular baseband processor(s) 1524 and the application processor(s) 1506. The tracking component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for obtaining an indication of a PDoA function related to the first UE. The apparatus 1504 may further include means for obtaining a set of PDoA measurements associated with a second UE when the first UE is associated with a plurality of orientations. The apparatus 1504 may further include means for computing, based on the PDoA function, the set of PDoA measurements, and the plurality of orientations of the first UE, a general function that is associated with a probability in which the second UE is at a set of relative directions compared to the first UE. The apparatus 1504 may further include means for estimating, based on the computed general function, a relative direction of the second UE compared to the first UE, where the relative direction is included in the set of relative directions.

In one configuration, the PDoA function is a function g(θ,ϕ) that calculates an ideal or hypothetical PDoA value for a signal from a given set of points (θ,ϕ), where θ is azimuth and ϕ is elevation.

In another configuration, the PDoA function related to the first UE is associated with Bluetooth® ranging, Wi-Fi® ranging, or ultra-wideband (UWB) ranging.

In another configuration, the means for obtaining the indication of the PDoA function may include configuring the apparatus 1504 to at least one of: obtain the indication of the PDoA function via a calibration process, obtain the indication based on a LUT, receive the indication from another device or a network entity, or obtain the indication based on a pre-configuration.

In another configuration, the means for obtaining the set of PDoA measurements associated with the second UE when the first UE is associated with the plurality of orientations may include configuring the apparatus 1504 to receive, from the second UE, a set of signals at each orientation of the plurality of orientations, and measure a PDoA of the set of signals at each orientation of the plurality of orientations to obtain the set of PDoA measurements associated with the second UE. In some implementations, to receive the set of signals may include configuring the apparatus 1504 to receive the set of signals via at least two antennas.

In another configuration, the means for computing the general function that is associated with the probability in which the second UE is at the set of relative directions compared to the first UE may include configuring the apparatus 1504 to constrain possible values for the PDoA function based on the set of PDoA measurements and the plurality of orientations of the first UE, and build, based on the constrained possible values for the PDoA function, the general function that indicates a mismatch between the set of PDoA measurements and a set of hypothetical PDoA measurements from the PDoA function for a given candidate pair of points.

In another configuration, the means for estimating, based on the computed general function, the relative direction of the second UE compared to the first UE may include configuring the apparatus 1504 to determine, based on the computed general function, a set of points that provides a highest probability in which the second UE is at the set of points, and calculate, based on the set of points, the relative direction of the second UE compared to the first UE. In some implementations, to determine the set of points that provides the highest probability in which the second UE is at the set of points may include configuring the apparatus 1504 to use at least one minimization technique to find the set of points that achieves a minimum value for the computed general function. In some implementations, the at least one minimization technique includes a GD or a GA-GD.

In another configuration, the apparatus 1504 may further include means for outputting a request to rotate the first UE, and track the plurality of orientations of the first UE while the first UE is rotating. In some implementations, the means for tracking the plurality of orientations of the first UE may include configuring the apparatus 1504 to track the plurality of orientations of the first UE using at least one IMU, at least one camera, or a combination thereof.

In another configuration, the apparatus 1504 may further include means for obtaining distance information between the first UE and the second UE, and means for computing, based on the distance information and the relative direction of the second UE, a relative location of the second UE with respect to the first UE.

In another configuration, the apparatus 1504 may further include means for outputting an indication of the estimated relative direction of the second UE compared to the first UE. In some implementations, the means for outputting the indication of the estimated relative direction of the second UE compared to the first UE may include configuring the apparatus 1504 to transmit the indication of the estimated relative direction of the second UE compared to the first UE, display the indication via a screen or a user interface, or store the indication of the estimated relative direction of the second UE compared to the first UE.

In another configuration, the apparatus 1504 may further include means for displaying, via a UI, the computed relative direction of the second UE with respect to the first UE. In some implementations, the apparatus 1504 may further include means for displaying a distance of the second UE from the first UE, and/or an image or a description of the second UE.

In another example, the apparatus 1504 may further include means for providing, at a user interface (UI), at least one of (1) a first guidance for rotating the first UE, (2) a second guidance for rotating the first UE from a current orientation to an orientation within the plurality of orientations, or (3) a third guidance for moving the first UE towards a direction. In some implementations, the UI may include a graphical user interface (GUI) configured to display a first graphical icon that is configured to rotate as the first UE is rotated or a second graphical icon that is configured to move as the first UE is moved.

The means may be the tracking component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a first user equipment (UE), comprising: obtaining an indication of a phase difference of arrival (PDoA) function related to the first UE; obtaining a set of PDoA measurements associated with a second UE when the first UE is associated with a plurality of orientations; computing, based on the PDoA function, the set of PDoA measurements, and the plurality of orientations of the first UE, a general function that is associated with a probability in which the second UE is at a set of relative directions compared to the first UE; and estimating, based on the computed general function, a relative direction of the second UE compared to the first UE, wherein the relative direction is included in the set of relative directions.
Aspect 2 is the method of aspect 1, wherein the PDoA function is a function g(θ,ϕ) that calculates a hypothetical PDoA value for a signal from a given set of points (θ,ϕ), where θ is azimuth and ø is elevation.
Aspect 3 is the method of aspect 1 or aspect 2, wherein obtaining the indication of the PDoA function comprises at least one of: obtaining the indication of the PDoA function via a calibration process, obtaining the indication based on a lookup table (LUT), receiving the indication from another device or a network entity, or obtaining the indication based on a pre-configuration.
Aspect 4 is the method of any of aspects 1 to 3, wherein estimating, based on the computed general function, the relative direction of the second UE compared to the first UE comprises: determining, based on the computed general function, a set of points that provides a highest probability in which the second UE is at the set of points; and calculating, based on the set of points, the relative direction of the second UE compared to the first UE.
Aspect 5 is the method of any of aspects 1 to 4, wherein determining the set of points that provides the highest probability in which the second UE is at the set of points comprises: using at least one minimization technique to find the set of points that achieves a minimum value for the computed general function.
Aspect 6 is the method of any of aspects 1 to 5, wherein the at least one minimization technique includes gradient descent (GD) or a generic algorithm with gradient descent (GA-GD).
Aspect 7 is the method of any of aspects 1 to 6, wherein computing the general function that is associated with the probability in which the second UE is at the set of relative directions compared to the first UE comprises: constraining possible values for the PDoA function based on the set of PDoA measurements and the plurality of orientations of the first UE; and building, based on the constrained possible values for the PDoA function, the general function that indicates a mismatch between the set of PDoA measurements and a set of hypothetical PDoA measurements from the PDoA function for a given candidate pair of points.
Aspect 8 is the method of any of aspects 1 to 7, wherein obtaining the set of PDoA measurements associated with the second UE when the first UE is associated with the plurality of orientations comprises: receiving, from the second UE, a set of signals at each orientation of the plurality of orientations; and measuring a PDA of the set of signals at each orientation of the plurality of orientations to obtain the set of PDoA measurements associated with the second UE.
Aspect 9 is the method of any of aspects 1 to 8, wherein receiving the set of signals comprises: receiving the set of signals via at least two antennas.
Aspect 10 is the method of any of aspects 1 to 9, further comprising: obtaining distance information between the first UE and the second UE; and computing, based on the distance information and the relative direction of the second UE, a relative location of the second UE with respect to the first UE.
Aspect 11 is the method of any of aspects 1 to 10, further comprising: outputting a request to rotate the first UE; and tracking the plurality of orientations of the first UE while the first UE is rotating.
Aspect 12 is the method of any of aspects 1 to 11, wherein tracking the plurality of orientations of the first UE comprises: tracking the plurality of orientations of the first UE using at least one inertial measurement unit (IMU), at least one camera, or a combination thereof.
Aspect 13 is the method of any of aspects 1 to 12, wherein the PDoA function related to the first UE is associated with Bluetooth® ranging, Wi-Fi® ranging, or ultra-wideband (UWB) ranging.
Aspect 14 is the method of any of aspects 1 to 13, further comprising: outputting an indication of the estimated relative direction of the second UE compared to the first UE.
Aspect 15 is the method of any of aspects 1 to 14, wherein outputting the indication of the estimated relative direction of the second UE compared to the first UE comprises: transmitting the indication of the estimated relative direction of the second UE compared to the first UE, displaying the indication via a screen or a user interface, or storing the indication of the estimated relative direction of the second UE compared to the first UE.
Aspect 16 is the method of any of aspects 1 to 15, further comprising: displaying, via a user interface (UI), the computed relative direction of the second UE with respect to the first UE.
Aspect 17 is the method of any of aspects 1 to 16, further comprising: display, via the UI, at least one of: a distance of the second UE from the first UE, or an image or a description of the second UE.
Aspect 18 is the method of any of aspects 1 to 17, further comprising: providing, at a user interface (UI), at least one of (1) a first guidance for rotating the first UE, (2) a second guidance for rotating the first UE from a current orientation to an orientation within the plurality of orientations, or (3) a third guidance for moving the first UE towards a direction.
Aspect 19 is the method of any of aspects 1 to 18, wherein the UI comprises a graphical user interface (GUI) configured to display a first graphical icon that is configured to rotate as the first UE is rotated or a second graphical icon that is configured to move as the first UE is moved.
Aspect 20 is an apparatus for wireless communication at a first user equipment (UE), including: at least one memory; and at least one processor coupled to the at least one memory and, based at least in part on stored information that is stored in the at least one memory, the at least one processor, individually or in any combination, is configured to implement any of aspects 1 to 19.
Aspect 21 is the apparatus of aspect 20, further including at least one transceiver coupled to the at least one processor.
Aspect 22 is an apparatus for wireless communication at a first user equipment (UE) including means for implementing any of aspects 1 to 19.
Aspect 23 is a computer-readable medium (e.g., a non-transitory computer-readable medium) storing computer executable code, where the code when executed by a processor causes the processor to implement any of aspects 1 to 19.

What is claimed is:

1. An apparatus for wireless communication at a first user equipment (UE), comprising:
at least one memory; and
at least one processor coupled to the at least one memory, the at least one processor, individually or in any combination, is configured to:
obtain an indication of a phase difference of arrival (PDoA) function related to the first UE;
obtain a set of PDoA measurements associated with a second UE when the first UE is associated with a plurality of orientations;
compute, based on the PDoA function, the set of PDoA measurements, and the plurality of orientations of the first UE, a general function that is associated with a probability in which the second UE is at a set of relative directions compared to the first UE; and
estimate, based on the computed general function, a relative direction of the second UE compared to the first UE, wherein the relative direction is included in the set of relative directions.

2. The apparatus of claim 1, wherein the PDoA function is a function g(θ,ϕ) that calculates an ideal or hypothetical PDoA value for a signal from a given set of points (θ,ϕ), where θ is azimuth and ϕ is elevation.

3. The apparatus of claim 1, wherein to obtain the indication of the PDoA function, the at least one processor, individually or in any combination, is configured to at least one of:
obtain the indication of the PDoA function via a calibration process,
obtain the indication based on a lookup table (LUT),
receive the indication from another device or a network entity, or
obtain the indication based on a pre-configuration.

4. The apparatus of claim 1, wherein to estimate, based on the computed general function, the relative direction of the second UE compared to the first UE, the at least one processor, individually or in any combination, is configured to:
determine, based on the computed general function, a set of points that provides a highest probability in which the second UE is at the set of points; and
calculate, based on the set of points, the relative direction of the second UE compared to the first UE.

5. The apparatus of claim 4, wherein to determine the set of points that provides the highest probability in which the second UE is at the set of points, the at least one processor, individually or in any combination, is configured to:
use at least one minimization technique to find the set of points that achieves a minimum value for the computed general function.

6. The apparatus of claim 5, wherein the at least one minimization technique includes gradient descent (GD) or a generic algorithm with gradient descent (GA-GD).

7. The apparatus of claim 1, wherein to computing the general function that is associated with the probability in which the second UE is at the set of relative directions compared to the first UE, the at least one processor, individually or in any combination, is configured to:
constrain possible values for the PDoA function based on the set of PDoA measurements and the plurality of orientations of the first UE; and
build, based on the constrained possible values for the PDoA function, the general function that indicates a mismatch between the set of PDoA measurements and a set of hypothetical PDoA measurements from the PDoA function for a given candidate pair of points.

8. The apparatus of claim 1, wherein to obtain the set of PDoA measurements associated with the second UE when the first UE is associated with the plurality of orientations, the at least one processor, individually or in any combination, is configured to:
receive, from the second UE, a set of signals at each orientation of the plurality of orientations; and
measure a PDoA of the set of signals at each orientation of the plurality of orientations to obtain the set of PDoA measurements associated with the second UE.

9. The apparatus of claim 8, wherein to receiving the set of signals, the at least one processor, individually or in any combination, is configured to:
receive the set of signals via at least two antennas.

10. The apparatus of claim 1, wherein the at least one processor, individually or in any combination, is further configured to:
obtain distance information between the first UE and the second UE; and
compute, based on the distance information and the relative direction of the second UE, a relative location of the second UE with respect to the first UE.

11. The apparatus of claim 1, wherein the at least one processor, individually or in any combination, is further configured to:
output a request to rotate the first UE; and
track the plurality of orientations of the first UE while the first UE is rotating.

12. The apparatus of claim 11, wherein to tracking the plurality of orientations of the first UE, the at least one processor, individually or in any combination, is configured to:
track the plurality of orientations of the first UE using at least one inertial measurement unit (IMU), at least one camera, or a combination thereof.

13. The apparatus of claim 1, wherein the PDoA function related to the first UE is associated with Bluetooth® ranging, Wi-Fi® ranging, or ultra-wideband (UWB) ranging.

14. The apparatus of claim 1, wherein the at least one processor, individually or in any combination, is further configured to:
output a second indication of the estimated relative direction of the second UE compared to the first UE.

15. The apparatus of claim 14, further comprising at least one of a transceiver or an antenna coupled to the at least one processor, wherein to output the second indication of the estimated relative direction of the second UE compared to the first UE, the at least one processor, individually or in any combination, is configured to:
transmit, via at least one of the transceiver or the antenna, the second indication of the estimated relative direction of the second UE compared to the first UE,
display the second indication via a screen or a user interface (UI), or
store the second indication of the estimated relative direction of the second UE compared to the first UE.

16. The apparatus of claim 1, further comprising a user interface (UI), wherein the at least one processor, individually or in any combination, is further configured to:
provide, at the UI, at least one of (1) a first guidance for rotating the first UE, (2) a second guidance for rotating the first UE from a current orientation to an orientation within the plurality of orientations, or (3) a third guidance for moving the first UE towards a direction.

17. The apparatus of claim 16, wherein the UI comprises a graphical user interface (GUI) configured to display a first graphical icon that is configured to rotate as the first UE is rotated or a second graphical icon that is configured to move as the first UE is moved.

18. A method of wireless communication at a first user equipment (UE), comprising:
obtaining an indication of a phase difference of arrival (PDoA) function related to the first UE;
obtaining a set of PDoA measurements associated with a second UE when the first UE is associated with a plurality of orientations;
computing, based on the PDoA function, the set of PDoA measurements, and the plurality of orientations of the first UE, a general function that is associated with a probability in which the second UE is at a set of relative directions compared to the first UE; and
estimating, based on the computed general function, a relative direction of the second UE compared to the first UE, wherein the relative direction is included in the set of relative directions.

19. The method of claim 18, further comprising:
outputting a request to rotate the first UE; and
tracking the plurality of orientations of the first UE while the first UE is rotating.

20. An apparatus for wireless communication at a first user equipment (UE), comprising:
a user interface (UI);
at least one memory; and
at least one processor coupled to the at least one memory, the at least one processor, individually or in any combination, is configured to:
obtain an indication of a phase difference of arrival (PDoA) function related to the first UE;
provide, at the UI, guidance for rotating the first UE from a current orientation to an orientation within a plurality of orientations;
obtain a set of PDoA measurements associated with a second UE when the first UE is associated with the plurality of orientations;
compute, based on the PDoA function, the set of PDoA measurements, and the plurality of orientations of the first UE, a general function that is associated with a probability in which the second UE is at a set of relative directions compared to the first UE; and
estimate, based on the computed general function, a relative direction of the second UE compared to the first UE, wherein the relative direction is included in the set of relative directions.
